(19) United States
(12) Patent Application Publication
(10) Pub. No.: US 2020/0153323 A1
(43) Pub. Date: May 14, 2020

(54) EXPANDABLE AI ARTIFICIAL INTELLIGENCE DRIVING FORCE, ELECTRICITY GENERATOR MULTI-STATOR MULTI-FUNCTION MOTORAND SYSTEM DEVICES

(71) Applicant: Yin-Shen HSIUNG, Taipei City (TW)

(72) Inventor: Yin-Shen HSIUNG, Taipei City (TW)

(21) Appl. No.: 16/676,384

(22) Filed: Nov. 6, 2019

(30) Foreign Application Priority Data
Nov. 8, 2018 (TW) 107215228

(51) Int. Cl. H02K 16/04; H02K 7/00; H02K 7/02; H02K 11/00; H02K 11/04; H02K 13/00; H02K 51/00

(52) U.S. Cl. CPC H02K 16/04; H02K 7/006; H02K 7/025; H02K 51/00; H02K 11/04; H02K 13/003; H02K 11/0094

(57) ABSTRACT

The present invention is a permanent magnet external-rotating brushless motor and an induction motor. It is multi-stabilized in order to fully utilize the characteristics of a magnetic field of 360 degrees, and is multi-functionalized by a wire group selection switch, and multi-stator multi-function The different stator-to-stator line sets are connected to the output power generation or the power supply drive to select different combinations of functions, such as a programmable logic controller module or a 32-bit 32-channel multi-channel servo steering control module, and the execution of the array module is written. The modes are grouped into action groups, and then the computer is used to assist the driver in making decisions by analyzing the artificial road and the road type with artificial intelligence decision trees.

### BACKGROUND

### 1. Technical Field

The present disclosure relates a permanent magnet external-rotating brushless motor and an induction motor.

### 2. Related Art

The sources of charging power for electric vehicles today are all charged by conventional electric power such as nuclear power, natural gas, coal, wind power or solar power, so it is actually only the cost and pollution of burning gasoline. Indirect transfer to traditional power generation methods is not a fundamental solution.

In addition, the design of today's multi-stator motors is mainly permanent magnet external-type brushless motors. The switch selection between the stators needs to be manually operated. The degree of automation is still enhanced, and the rotor and stator sets are not expandable. In addition, the motors that provide power and power generation, in addition to permanent magnet three-phase brushless motors, many electric vehicles and large-scale wind power generation, and nuclear power generation motor units are more inductive motors, single stator design, not yet effective It is a pity to multiply the power and torque by fully utilizing the 360-degree magnetic field of the magnet in a multi-stator structure.

In addition, in the power generation recharging system, the power generated by the multi-stator motor and the multi-stator motor of the wheel-wheel type multi-stator motor in the four-wheel wheel frame absorbs power only by the traditional lead-acid battery, and the environmental protection needs to be improved, and the volume and The weight is relatively large. If the lithium battery is used, the general lithium battery power management BMS power management system can not absorb the huge electric energy in time to protect the lithium battery from the over-current expansion damage or even the explosion to cause safety problems. Causes a large amount of charging current loss and waste. Therefore, all the above kinds of defects are the long-term shortcomings that users and those involved in related industries cannot break through. In view of this, how can we make multi-stator multi-function motors. Increase automation and extend to induction motors. Combined with online real-time traffic conditions and Google Maps map 3D analysis and big data trend analysis, motor power and power generation are more scalable. The application of multi-stator and multi-function motors is extended to inductive motors. At the same time, the power generation of the drive motor and the power generation of the four-wheel multi-stator hub-type motor can quickly absorb and continuously charge the lithium battery for the vehicle, how to generate electricity by electricity, and use the inductive motor to excite the coil winding electromagnet at a low cost. The large output characteristics to avoid the potential problems and hidden concerns caused by the large use of rare earth magnets and the high concentration of production areas in mainland China are the subjects that current users and related companies are eager to develop.

The above information disclosed in this section is only for enhancement of understanding of the background of the described technology and therefore it may contain information that does not form the prior art that is already known to a person of ordinary skill in the art.

### SUMMARY OF THE INVENTION

The creator is aiming at the above-mentioned shortcomings of the multi-stator brushless motor of the electric vehicle and the generator, and actively develops and creates the professional experience and experience of the company after many years of work, so the creation and creation of the case. The main purpose of the present invention is to design the induction motor and the permanent magnet brushless motor through the hollow rotor, so that the electromagnet of the permanent magnet and the excitation coil winding group can penetrate the rotor wall through the inner and outer sides of the rotor. Wherein, the common rotor shaft of the excitation winding coil group is sleeved into the collector ring to supply power to the excitation winding coil group, and the collector ring brush is locked on the inner stator group to supply power to the common rotor excitation winding The wire coil group is energized to generate a magnetic field, and a set of stator groups is additionally arranged on the outer side of the rotor, so as to fully utilize the characteristics of the magnetic field of the permanent magnet magnet and the excitation coil winding group to have a 360-degree magnetic field, thereby becoming a multi-stator and multi-function. The motor, in addition, due to the difference between the function of the motor and the generator is mainly due to the power supply to the motor electronic governor to drive the mechanical kinetic energy or to rotate the motor shaft through the external force such as wind or hydraulic force to cause the magnetic pole transformation, because the magnetic line is continuously cut and the same Subsequent capacity energy, so if a pair of two-wire group selection switch is connected after each stator wire group, the same stator wire group can drive the power generation and power supply by external force. Switching between different functions, with multi-functional selectivity, and then selecting the function switches of all stators, according to different torque, different power generation, different road conditions and purposes, and combining and combining functions according to all the arrangements. The relative position of the selector switch is used as the position of the control positioning point of the servo servo. Define the position of the servo servos of each group, and write them into a group of actions in advance. For example, the high-torque power supply output mountaineering mode or off-road four-wheel drive mode when climbing a mountain, the stop and stop plane road in the urban area Mode power supply, power generation balance mode, highway long-time high-speed low-torque flywheel power generation back-flight mode, simple-action generator mode, etc., through satellite navigation coordinates and road type to distinguish the slope as the mountain, the urban road, Different servo servo switch group action sets such as expressway and off-road four-wheel drive, PLC programmable logic controller module or 32-bit 32-channel multi-pass servo controller module. According to the position of the satellite positioning coordinates and the road type, the network connection real-time condition and the automatic detection slope are automatically executed for each segment grouping action. To enhance the expandable AI artificial intelligence multi-stator, multi-functional power. The degree of automatic control of the generator motor system device to enhance the value of the industry. Therefore, when used in electric steam and locomotive, the automation degree of steam locomotive control can be greatly improved as the evolution of automobile driving, and the evolution of the self-discharging vehicle by the hand-cranked vehicle makes the operation more humanized and convenient.

Another object of the present invention is to make the number of common rotors and stators of the multi-stator multi-function external-rotating brushless motor system device to fully utilize the magnetic field of the magnet 360 degrees. An additional layer of rotor is added, and two stators are used to respectively charge a single stator to extend outward from the axis by using a magnetic field of a magnetic field of one hundred and eighty degrees. The demand for torsion and power generation is from a single-layer common rotor, and the dual-stator design structure evolves into a two-layer common rotor-to-four-stator model or a three-layer common rotor-to-six-state relationship. AI artificial intelligence multi-stator multi-function power, power generation motor system device. And a connection switch is added to the connection line group behind each stator to select between the functions of power generation charging and power supply driving force. Therefore, the torque and power generation of the new expandable AI artificial intelligence multi-stator multi-function power and power generation motor system device can be adjusted and changed according to requirements. When a large torque output is required, the common rotor is powered by the stator group close to the circumference of the motor. Rotate to increase the distance between the point of application and the fulcrum to achieve the effect of the lever principle. Conversely, when large power generation output is required or recharged to the battery, the common rotor rotation is preferentially driven by the stator group near the axis, and the other stator sets are outputted and rectified in parallel to charge the super capacitor and then recharged to the battery to receive the flywheel. The effect of energy storage. At the same time, it reduces the loss of mechanical energy kinetic energy consumed by the gear set due to rotation, and has increased the industrial utilization value of the expandable artificial intelligence multi-stator multi-function power generation motor system device. Therefore, when used for hydroelectric power generation, the vertical two-layer common rotor can be used according to the depth of the gate water flow, and the four-layer stator or the vertical three-layer common rotor can be extended with the six-layer stator combination to greatly increase the power generation efficiency.

The secondary purpose of the present invention is to use a conventional multi-stator multi-function motor. With a coaxial multi-layer rotor, the rotor wall hollowing magnet penetrates the inner and outer layers of the common rotor sleeve from the inside and the outside, and is coupled with the two stator sets and the expansion base and the multi-function selector switch to the full-wave rectifier group or the power supply drive for power generation. The relationship between the electronic governor forms a multi-stator expansion module, and the multi-layer common rotor sleeve is directly locked above the common rotor of the traditional double-stator multi-stator multi-function motor, and the two stators are locked on the expansion base to connect power generation and supply. The wire group selection switch is re-updated to the 32-bit multi-channel servo steering controller, and the array of multi-function selector switches of each stator group is rewritten into the database according to the output power, torque, power generation or road conditions. The action group is automatically executed according to the road condition requirement, so as to achieve the purpose of the expandable AI artificial intelligence power generation multi-custom sub-multi-function motor system device. At the same time, the common rotor and multi-stator expansion module can also be applied to a general external rotary brushless motor to simultaneously achieve the effect of the generator and the driving power motor to greatly improve the power generation efficiency or extend the driving distance of the electric motor vehicle. Improve the value of industrial use.

Another objective of the present invention is to provide an inductive motor through a bearing slip ring and a multi-layer hollow common rotor in addition to the permanent magnet brushless motor, so that the excitation winding coil group runs through the common The rotor and the two sides of the rotor wall are powered by the brush on the stator set to the collector ring on the rotor bearing to conduct a magnetic field generated by the field winding coil group running through the two sides of the layer of the rotor wall. The same grouping of two stator groups by a common rotor to fully utilize the 360-degree magnetic field of the magnetic pole, so that the inductive motor can also be a design solution for the multi-stator multi-function motor, so that the multi-layer common rotor and the multi-stator induction motor are also Like the permanent magnet type expandable AI artificial intelligence power generation multi-stator multi-function motor system device, the lever principle is used, and the flywheel power generation energy storage effect. To enhance the value of the industry. Due to the current large and medium-sized generators and motor units, such as electric vehicle wind turbines, nuclear power generation is mostly designed with inductive power generation motors. When used in electric vehicle wind power generation and nuclear power generation, it can effectively reduce costs and reduce rare earth magnets dependence.

The secondary purpose of the present invention is to provide an inductive motor via a wireless power transmitting module and a powerless receiving module and a multi-layer hollow common rotor in addition to the permanent magnet brushless motor, so that the exciting coil Through the two sides of the rotor wall of the common rotor rotor, the two-stage stator group is used to fully utilize the 360-degree magnetic field of the magnetic pole, and the wireless power supply transmitting module located on the stator group transmits the power to the power supply in an innocent manner. The inner side wireless power receiving module of the common rotor supplies power to the exciting winding coil on the common rotor to generate a magnetic field by the electromagnet, thereby making the induction motor wireless and brushless, and becomes a wireless inductive multi-stator multi-function motor. The design solution enables the wireless multi-layer common rotor and multi-stator inductive brushless motor to be equipped with a multi-stator multi-motor system as in the permanent magnet type AI artificial intelligence power generation multi-stator multi-function motor system. Can work. To enhance the value of the industry. Due to the current large and medium-sized generators and motor units, such as electric vehicle wind turbines, nuclear power generation uses induction motor design, so when used in electric vehicle wind power and nuclear power generation, it can effectively reduce costs and reduce rare earth magnets dependence.

Another objective of the present invention is to provide an expandable AI artificial intelligence power generation multi-stator multi-function motor system device, which is a driving motor power system that simultaneously generates power and power generation, and causes four when driving the vehicle. The tires rotate, and the large amount of AC power generated by the multi-stator motors in the wheel frame is converted into DC power in parallel by full-wave rectification, and a high-voltage and large-ampere super capacitor is placed in front of the power supply rechargeable battery pack. First, a large amount of DC current of the high-ampere number is quickly absorbed by the super capacitor, and then the lithium battery pack for the vehicle is continuously charged. In order to avoid the lithium battery pack for the vehicle, the power management system BMS is a current limiting protection measure for protecting the lithium battery from overfill expansion damage or even explosion, and cannot store the multi-stator multi-function of the four tires in the vehicle. The loss of the huge power generation current generated by the motor effectively recycles the power generated by the amount of running inertia during the vehicle travel to expand the travel distance and use time of the electric vehicle locomotive and various vehicles and home appliances.

Once again, the purpose of the present invention is to apply a driving computer and navigation module and a 4G network to pre-route the route to the destination. Analysis of options such as destination distance, road type, average speed, real-time traffic conditions in the cloud, power consumption, power generation, and flat road ratio. In order to estimate the time required to reach the destination and the remaining vehicle power after arriving at the destination, the shortest travel time and the most remaining power route are prioritized. As a result of the decision tree analysis, the driver is preferentially recommended. After the driver confirms the driving route and according to the road type according to the recommended road path, the corresponding type of the multi-function switch of the stator line group is selected according to the road type. The automatic deployment route task automatic allocation table automatically performs the multi-stator multi-function stator line group selection switch action group combination of the road segment according to the 3D coordinates of the satellite positioning. During the vehicle travel, the driving computer can be directly controlled by the PLC programmable logic controller module or the 32-bit 32-channel multi-channel servo steering controller by the automatic navigation module, and can also directly control the function switching switch action groups of each stator group. The GPS module of the automatic navigation module, the electronic compass, the gyroscope and other commands operate the throttle, the direction, the front and rear, the light, the brake, and the like, and the automatic detection of the optical radar, the tire pressure by the driving computer connected sensing fusion device Meters, accelerometer magnetometers, radars and CMOS cameras, G Sensors, inertia meters, pressure gauges, chemical sensors, ultrasonic sensors and other detection systems. Automatically scan the current situation of surrounding vehicles, and perform trend prediction analysis based on inertia and dynamics to remind drivers or take proactive measures before the obstacles in the path can be affected to achieve the purpose of AI artificial intelligence assisted driving.

Another objective of the present invention is to provide an expandable AI artificial intelligence power generation multi-stator multi-function motor system device, which supplies power to an electronic governor of a single stator close to the axis, and drives the common rotor to rotate. However, the power-driven tire transmission system is not output, and the other common rotor magnetic poles close to the circumference have a larger energy storage effect of the flywheel, and the near-circumferential stator group is subjected to the common rotor rotating magnetic field line to cut the stator and generate a larger current. Full-wave rectification into DC power supply for parallel recharging, placing a high-voltage large-ampere-capacity super capacitor in front of the power-supply rechargeable battery pack, firstly absorbing a large amount of DC current of high-ampere-amplitude by supercapacitor, and then performing the battery pack on the battery pack. Continuous charging, the battery pack is connected with 4000 watts DC to AC to AC pure rotary wave power converter, which becomes a generator mode that can output 110V or 220V household power for household appliances. The system can automatically adjust according to power consumption and battery voltage. Expandable AI artificial intelligence power generation multi-stator multi-function motor system device speed to achieve balance The purpose output. Therefore, the new type of electric vehicle with the expandable AI artificial intelligence power generation multi-stator multi-function motor system can become a small mobile power station when going out for camping and office work. When returning to the underground parking lot, it can be transmitted via the power transmission system. Electricity is transferred from the underground parking lot to the home for use by other household appliances to achieve special functions of energy saving and carbon reduction.

Another purpose of the present invention is to provide an expandable AI artificial intelligence power generation multi-stator multi-function motor system device, which supplies power to a single stator electronic governor close to the axis, driving the common rotor to rotate, However, the power-driven tire transmission system is not output, and the stator group close to the circumference is subjected to the common rotor rotation to generate the energy storage effect of the large inertia flywheel. The stator coil is subjected to the magnetic field transformation and cutting to generate an alternating current, and the fixed rotation speed is close to the circumferential power generation. The AC power generated by the large stator is adjusted to 110V via the transformer. The AC power output of 60 Hz is directly used by the household appliances. The AC power generated by the other stators is rectified by full-wave rectification into DC power for recharging in front of the battery pack. Into the high-capacity high-ampere-capacitor supercapacitor, the high-ampere-amplitude DC current is first absorbed by the supercapacitor, and then the battery pack is continuously charged. The battery pack is connected with 4000 watts of DC-to-AC to AC-spinning. The power converter can be used to output 110V or 220V household power for household appliances, so many In the stator group, the large amount of power generation directly depresses the generated AC power through the transformer to 110V output for household appliances, and the DC power supply of the battery is used for household appliances through a 4000 watt DC-to-AC power converter. Therefore, it is the generator mode of the maximum AC output with the direct output of the AC power transformer plus the 4000 watt DC to AC power converter output. The system can automatically adjust the expandable AI artificial intelligence power generation based on the power consumption and the battery voltage. The stator multi-function motor system sets the speed to achieve a balanced power output. Therefore, the new type of electric vehicle with the expandable AI artificial intelligence power generation multi-stator multi-function motor system can become a small mobile power station when going out for camping and office work. When returning to the underground parking lot, it can be transmitted via the power transmission system. Electricity is transferred from the underground parking lot to the home for use by other household appliances to achieve special functions of energy saving and carbon reduction.

Another objective of the present invention is to provide an expandable AI artificial intelligence power generation multi-stator multi-function motor system device to provide power. The core power multi-stator motor can be selected to supply power to a single stator close to the axis. The group of electronic governors drives the common rotor to rotate, but does not output the power to drive the vehicle to the tire drive system. It is only used as a generator that converts mechanical kinetic energy into electrical energy. Because the other cores of the multi-stator motor are close to the circumference of the stator group. When the common rotor rotates, the volume of the near circumference is larger, the magnetic pole is more, and the inertia amount is higher, which in turn generates the energy storage effect of the flywheel. Therefore, when the other multi-stator group function selection line group is connected to the functional position of the rectification power generation line group, The magnetic field line of the rotor is transformed and cut to generate an alternating current. After the full-wave rectification into a specific voltage, the direct current is connected in parallel to charge the super capacitor. First, a large amount of DC current of the large amperage can be quickly stored by the super capacitor to quickly store a large amount of DC power. And then continue to charge the car battery pack, at this time via the driving computer The 32-bit 32-channel servo controller or the PLC programmable logic controller selects the stator group selection switch combination as the four-wheel direct drive mode, that is, the power for driving the vehicle to move is directly supplied by the battery pack to the four tires of the vehicle. The electronic governor of the extended AI artificial intelligence power and power generation multi-stator multi-function motor directly drives the motor to generate mechanical kinetic energy, which drives the vehicle to move, so as to achieve the core power motor to become the generator, and the power generation to the four tire wheel frames can be expanded. AI artificial intelligence power generation multi-stator multi-motor direct drive four-wheel drive mode, in order to achieve the maneuverability in the core power multi-stator multi-function motor to provide power to drive the vehicle to move the four-wheel tire to become four multi-stator generators, And the whole-wave rectification parallel recharge battery recirculates the power of the urban flat road mode or the core power motor to become a multi-stator generator section parallel recharge battery, and then the battery-powered four-wheel tire multi-stator multi-function motor power supply drive Become a mountaineering mode for the active four-wheel drive power source, and achieve two-wheel drive in the urban area. The flat road life mode, optional four-wheel drive mode for mountaineering off-road to adapt to the special features of the entire road.

It is known that the effective magnetic fields of the permanent magnet and the electromagnet are both 360 degrees, and the characteristics of the magnetic field of 360 degrees can be effectively utilized. If a double stator is used to coat a single permanent magnet or electromagnet on the rotor of the externally rotating brushless motor The combination method can make full use of the complete magnetic field of the magnet 360 degrees, and then can be laterally expanded according to the ratio of permanent magnets or electromagnets on the outer rotor layer of the two stators according to the requirements of the torque or the amount of power generation. The number of outer rotor layers of the motor is used to increase the torque or power generation; the difference between the motor and the generator is that the stator of the power supply winding consumes electric power to generate a magnetic field to drive the rotor to generate power, which is called a motor; and the generator is The force rotates the rotor. Because the north and south magnetic poles on the rotor continuously change and generate electricity on the winding stator, it is called a generator. Therefore, the difference between the motor and the generator is that when the motor is used as a motor, the rear end of the stator wire group is used. The device is powered by an electronic transmission, or when the rotor is driven by an external force and used as a generator, the generated alternating current is converted to a direct current via a full-wave rectifier. And for storage, and therefore it plus a set of line selector after the stator group can be in the motor or generator that is a transmission electron i.e., switching between full-wave rectifier according to the required function. The present invention relates to a permanent magnet external-rotating brushless motor and an induction motor. In order to fully utilize the characteristics of a magnetic field of 360 degrees, the stator and the stator are coated with a permanent magnet or an electromagnet on the rotor. Each single stator wire group is multi-functionalized by connecting a pair of multi-wire group selection switches, and the different stator-to-stator sets of the inductive and permanent-magnet multi-stator multi-function motors are selectively connected to output power generation or power generation. The driving force and other function selection switches are arranged and combined, and the speed generation capacity and the torque and the different output sizes are pre-classified and arranged according to the road condition, and the switch position of the different stator power supply output and the input line group is defined according to each combination. The combined servo servo performs the position mode, and the programmable logic controller module or the 32-bit 32-channel multi-channel servo steering control module is pre-written into the execution mode of each array combination module, and then integrated into an action group. group. And through the setting of the target, let the computer, through the network real-time traffic conditions, satellite GPS and different stator group RPM speed power generation database to establish and analyze the basis to make the best recommended path and arrangement, according to the proposed path and section to do The selection and combination analysis of the multi-function selector switches between the stators is performed automatically, and the action groups are automatically executed according to the GPS satellite positioning. For example, after entering the destination location in the Google Map, the map 3D analysis is performed, and the different road sections and different road conditions are based on the GPS coordinates. The position is automatically executed such as urban driving mode, highway driving mode, mountain climbing mode, uphill mode, and automatic detection mode. The most immediate artificial intelligence decision tree analysis mode is used to assist the driver in making decisions.

Among them, the urban driving mode, the highway mode, the climbing mode, the uphill mode, and the downhill mode are a different execution action group. In addition, in order to have more expansion flexibility, a coaxial concentric multi-layer rotor group is added, and the expansion of the multi-layer stator is adopted, so that the double stator design which originally needs to fully utilize the 360-degree magnetic field of the magnet can be rapidly expanded into a two-layer common rotor-to-four-stator. A multi-stator multi-function motor with a three-layer common rotor and six stators to increase the torque of the motor or increase the amount of power generated.

When it is necessary to increase the amount of power generation, the common rotor is driven by the stator power supply close to the center of the circle, and the stator close to the circumference is used for power generation. Due to the large number of poles close to the circumference of the stator magnet, the volume of the stator winding is relatively high. The closer the circumference of the common rotor is, the larger the mass is, the larger the inertia is. Therefore, the larger the diameter of the rotor itself has the energy storage effect of the flywheel, so the motor and The generator operates in the same body at the same time, and uses the wheel frame of the four tires of the vehicle as a multi-stator multi-function hub-type motor generator, so that more power generation can be generated and connected via an automatic buck-boost controller via full-wave rectification. After the capacitor is charged, the lithium battery is charged for a long time by the super capacitor. In order to achieve the effect of energy recycling energy.

When more torque is needed, the stator of the near circumference is preferentially selected to supply power to drive the outer circumference of the common rotor. The distance between the point of application and the fulcrum is greater than that of the lever principle or all the stator sets are connected to the power supply. The common rotor simultaneously outputs a larger torque.

Many of the attendant features and advantages of the present invention will become better understood with reference to the following detailed description considered in connection with the accompanying drawings.

### BRIEF DESCRIPTION OF THE DRAWINGS

The embodiments will become more fully understood from the detailed description and accompanying drawings, which are given for illustration only, and thus are not limitative of the present disclosure, and wherein:

FIG. 1 is a three-dimensional diagram of the AI artificial intelligence power, power generation multi-stator multi-function motor and system device;

FIG. 2 is a three-dimensional diagram of the components of this creation (1);

FIG. 3 is a three-dimensional diagram of the components of this creation (2);

FIG. 4 is a three-dimensional diagram of the components of this creation (3);

FIG. 5 is a three-dimensional diagram of the components of this creation;

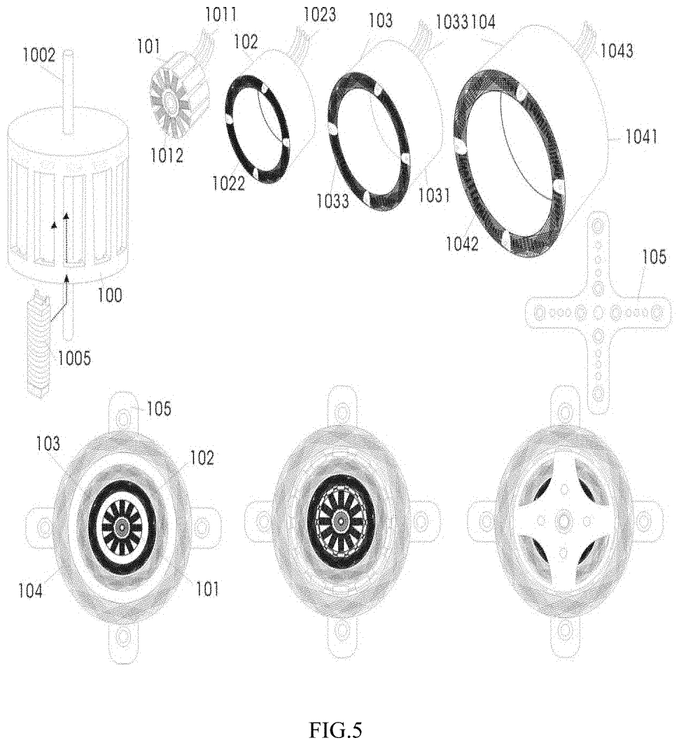

FIG. 6 is a three-dimensional decomposition diagram of the creation (1);

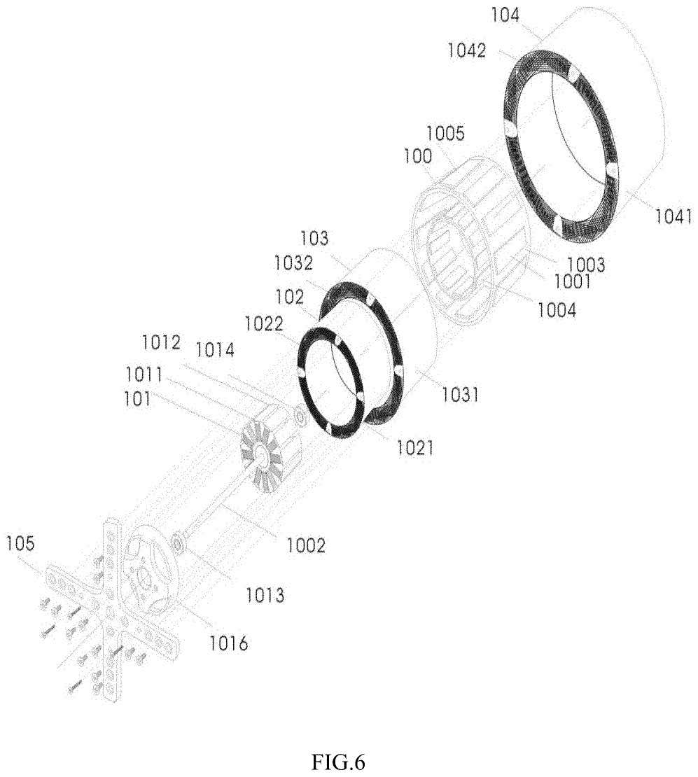

FIG. 7 is a three-dimensional decomposition diagram of the creation (2);

FIG. 8 is a three-dimensional exploded view of the creation (3);

FIG. 9 is a perspective view (1) of a preferred embodiment of the present invention;

FIG. 10 is a perspective view (2) of another preferred embodiment of the present invention;

FIG. 11 is a perspective view (3) of another preferred embodiment of the present invention;

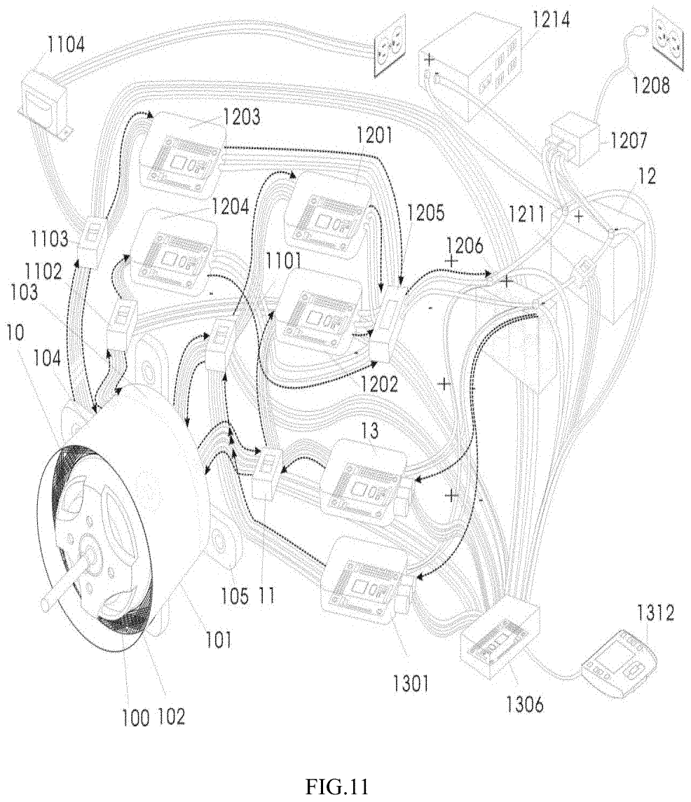

FIG. 12 is a perspective view (4) of another preferred embodiment of the present invention;

FIG. 13 is a perspective view (5) of another preferred embodiment of the present invention;

FIG. 14 is a perspective view (6) of another preferred embodiment of the present invention;

FIG. 15 is an analysis decision diagram (1) of another preferred embodiment of the present invention;

FIG. 16 is a system architecture diagram (2) of another preferred embodiment of the present invention;

FIG. 17 is a perspective view (7) of another preferred embodiment of the present invention;

FIG. 18 is a perspective view (8) of another preferred embodiment of the present invention;

FIG. 19 is a perspective view (9) of another preferred embodiment of the present invention;

FIG. 20 is a perspective view (10) of another preferred embodiment of the present invention;

FIG. 21 is a perspective view (11) of another preferred embodiment of the present invention;

FIG. 22 is a perspective view (12) of another preferred embodiment of the present invention;

FIG. 23 is a perspective view (13) of another preferred embodiment of the present invention;

FIG. 24 is a perspective view (14) of another preferred embodiment of the present invention; and

FIG. 25 is a perspective view of another preferred embodiment of the present creation (15).

### DETAILED DESCRIPTION OF THE INVENTION

Reference will now be made in detail to the exemplary embodiments of the present invention, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this invention will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way.

For convenience, certain terms employed in the specification, examples and appended claims are collected here. Unless defined otherwise, all technical and scientific terms used herein have the same meaning as commonly understood by one of the ordinary skill in the art to which this invention belongs.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

The following definition is applied in all disclosure of the present invention. The weight percentage of all polymers, gels, and other materials is represented by dry weight basis. The term “polymer” means homopolymer and copolymer.

The singular forms “a”, “and”, and “the” are used herein to include plural referents unless the context clearly dictates otherwise.

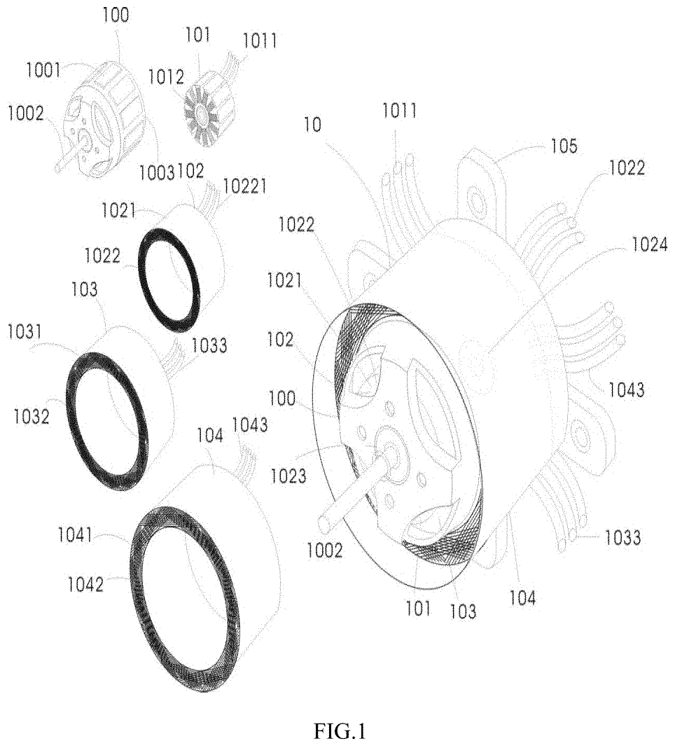

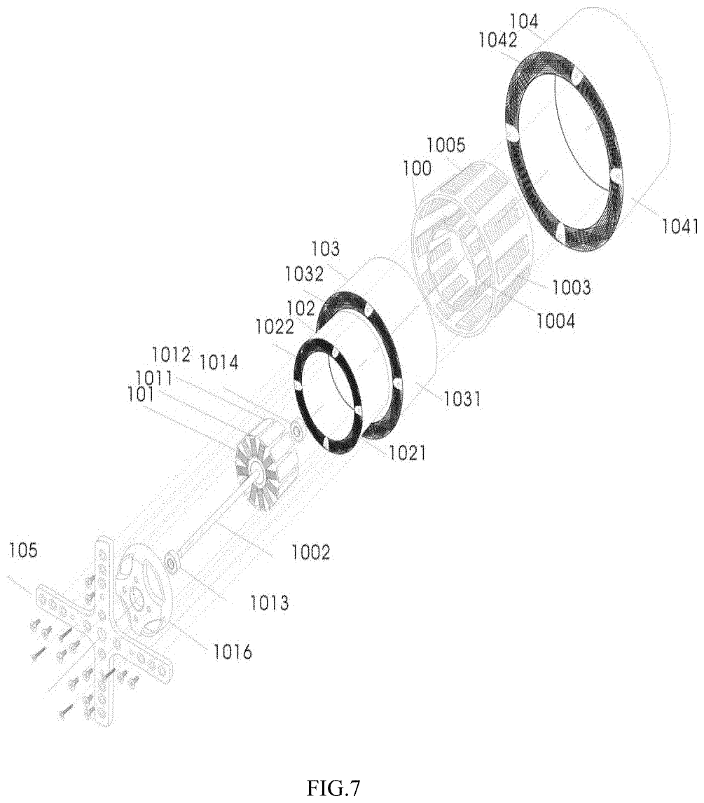

Please refer to FIG. 1˜FIG. 7, and the preferred expandable AI artificial intelligence of the present invention Power and power generation multi-stator multi-function motor is the system (10) multi-layer common rotor (100) mining (embedded) design, the permanent magnet magnet (1001) and embedded excitation coil winding group (1005) can be inserted (Inlay) into the hollow of the multi-layer common rotor body (1003), so that the magnetic field can fully exert the magnetic field performance of 360 degrees, and is fixed to the stator front ball bearing (1012) in the inner stator coil assembly (101) by the rotor bearing (1002) and the inner word rear ball bearing (1013), so that the multi-layer common rotor (100) is driven to rotate by the motor electronic transmission (13), so that the magnetic field around the multi-layer common rotor (100) also rotationally drives the fluctuating magnetic pole. At this time, an outer stator coil (102) is disposed outside the multi-layer common rotor (100), and is composed of an outer stator coil winding (1021) and an outer stator coil housing (1022), and then added to the outer stator coil assembly. a certain sub-line The group (103) is composed of an outer stator coil winding (1031) and an outer stator coil housing (1032), and then an outer two stator coil assembly (104) is added outside the outer stator. The stator coil winding (1041) and the outer two stator coil housing base (1042) are integrally wrapped and fixed to the inner base (101) on the cross base (105), and then driven by the inner stator (101). When the multi-layer common rotor (100) rotates (mechanical energy/kinetic energy generated by electric energy, the outer stator coil group (102) and the multi-layer common rotor outer layer (1003) are externally bounded by the outer magnetic field lines of the inner layer (1004) of the multi-layer common rotor. The cutting and transformation of the coil assembly (103) and the outer two stator coil assembly (104) are recovered by the outer stator coil (102) and the outer stator coil assembly (103) and the outer two stator coil assembly (104) to generate electrical energy (by The mechanical energy/kinetic energy generates electric energy) and then outputs an alternating current to the full-wave rectification automatic buck-boost controller via the outer stator power line (1023), the outer stator power line (1033), and the outer two stator power line (1043). 1) AC rectifier voltage controller (1202) and wave rectifier automatic buck-boost controller (1203) for AC/DC conversion and output stable DC parallel connection to battery automatic charge controller (1205) to super capacitor group (1206) The supercapacitor can quickly absorb the characteristics of a large amount of direct current, rectify the power generating stator group into DC power and then absorb and store it, then charge and store the battery (12), and avoid overcharging to damage the battery to achieve power consumption. At the same time, it also creates electricity, which can be used in an infinitely cyclical way. The power source can be designed according to the effective utilization of the magnetic field, the number of coil turns and the amount of power generated, and the load is designed to extend the distance between the electric steam and the locomotive efficacy.

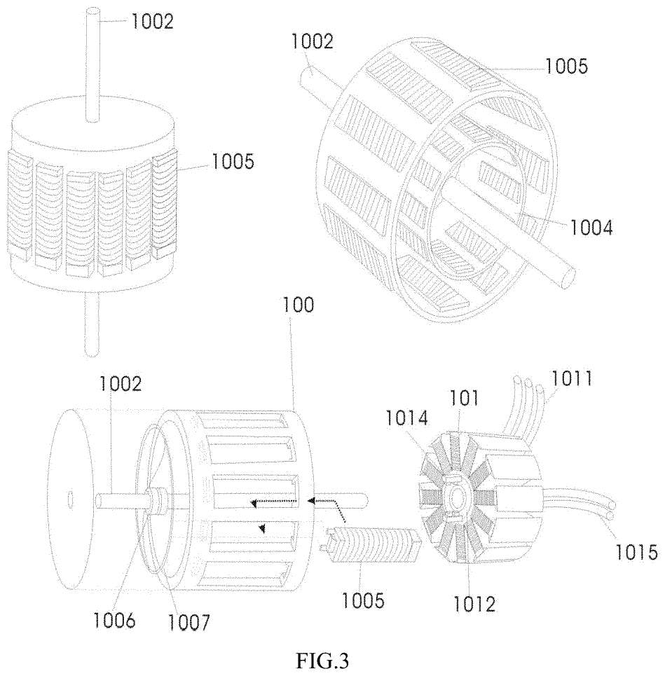

Please refer to the FIG. 3, the scalable AI artificial intelligence power, power generation multi-stator multi-function motor and system device preferably implemented in the present invention, so that the inductive type can also fully utilize the multi-layer common rotor (100) 360-degree omnidirectional magnetic field characteristics, so the multi-layer common rotor shaft (1002) of the excitation winding coil set (1005) is sleeved into the collector ring (1006) to supply excitation coil winding wire (1007) to the excitation The winding coil set (1005), and the collector ring brush (1014) is locked on the inner stator set (101), and is excited by the contact slip ring (1006) when the multilayer common rotor (100) is placed. The coil winding wire (1007) is powered by the power supply brush power line (1015) to energize the multiple common rotor (1004) located in the inner layer and the exciting winding coil set (1005) in the outer multilayer common rotor (1003). The magnetic field forms an inductive electromagnet, which is like a permanent magnet multi-stator and multi-function brushless motor. It has become a design solution for an inductive multi-stator multi-function motor, which can achieve more than AI artificial intelligence power generation. Stator multi-function motor system like device, make pars bar principle, and flywheel energy storage efficiency of power generation. In order to enhance the value of the industry, and effectively reduce costs and reduce dependence on rare earth magnets.

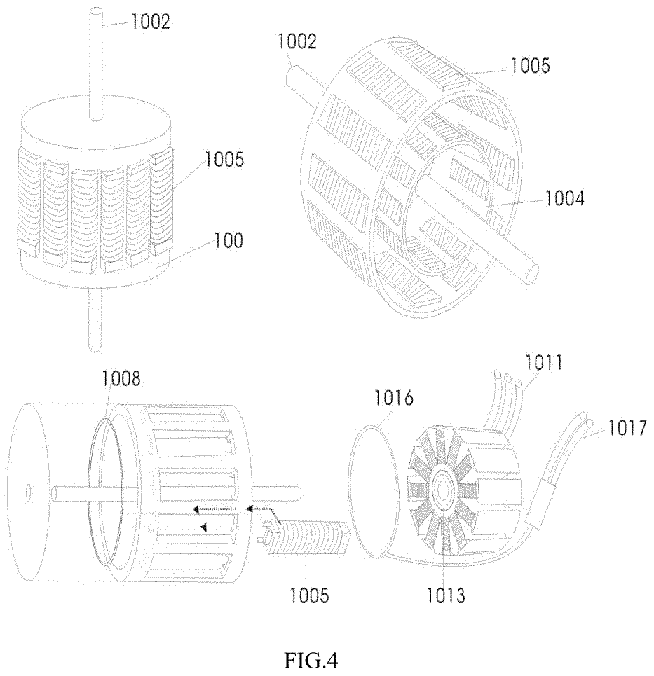

Please refer to FIG. 4, the scalable AI artificial intelligence power, power generation multi-stator multi-function motor and system device preferably implemented in the present invention, so that the inductive type can also fully utilize the multi-layer common rotor (100) 360 degree omnidirectional magnetic field characteristics, so the upper part of the multi-layer common rotor (100) of the excitation winding coil group (1005) is placed into the excitation coil winding group wireless power receiving wire (1008) to supply power to the excitation winding coil Group (1005), and the wireless power supply wireless transmitting module (1016) is locked into the inner stator group (101). When the multilayer common rotor (100) is placed, the wireless power receiving wire of the exciting coil winding group (1008) The wireless power supply wireless transmission module (1016) is powered by the wireless power supply wireless transmission module power supply line (1017) to the multi-common rotor (1004) and the outer layer multi-layer common rotor located in the inner layer within the effective wireless power transmission receiving distance (In 1003), the excitation winding coil set (1005) is energized to generate a magnetic field, forming an inductive electromagnet, which is like a permanent magnet multi-stator and a multi-function brushless motor, and becomes a wireless inductive multi-stator The motor can design solutions, such as permanent magnet can reach Expandable AI Artificial Intelligence power generation systems and more motor stators multifunction devices like, make pars bars principle, energy storage flywheel effect and power generation. In order to enhance the value of the industry, and effectively reduce costs and reduce dependence on rare earth magnets.

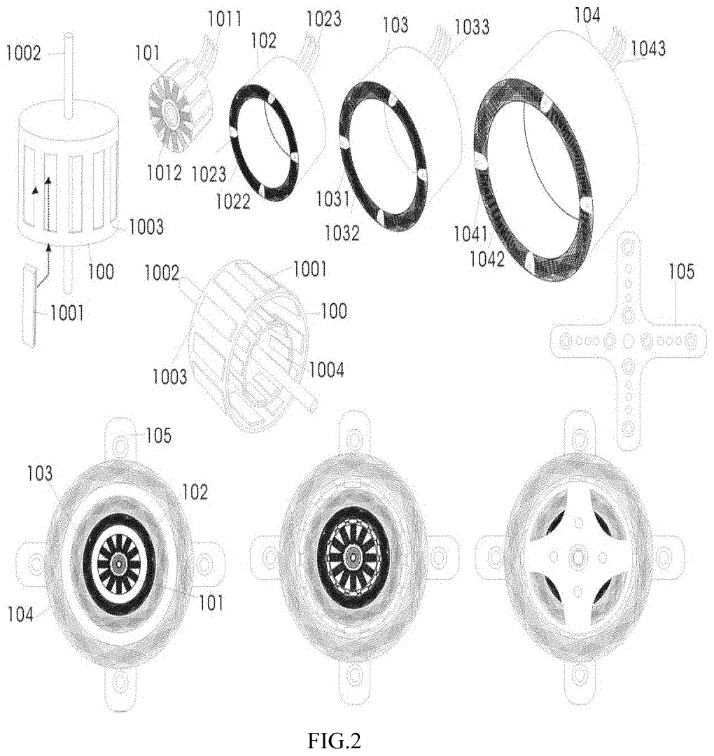

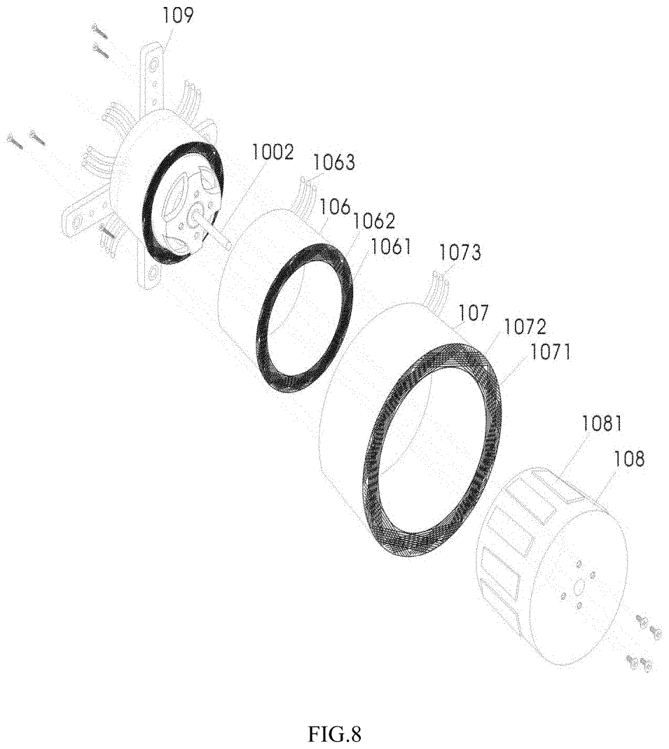

Please refer to FIG. 8 and FIG. 2, the scalable AI artificial intelligence power, power generation multi-stator multi-function motor and system device preferably implemented in the present invention are to fully utilize the magnetic field of the magnet 360 degrees. According to the demand, the power generation capacity of the motor can be expanded or the torque can be increased, and a common rotor expansion set (108) can be added, and the external three-expansion stator coil winding (1061) can be expanded by the outer three expansion stator coil group (106). The outer three expansion stator coil base (1062), the outer three extended stator power supply line (1063) and the outer four extended stator coil group two stators (107) are expanded by the outer four extended stator coil winding (1071), the outer four expansion The stator coil base (1072) and the outer four extended stator power supply line (1073) are respectively configured to respectively use a single stator to extend outward from the axial center by using a magnetic field of a magnetic field of one hundred and eighty degrees. The demand for torsion and power generation consists of a single-layer common rotor, a two-stator design structure that evolves into a multi-layer common rotor-to-four-sector model or a three-layer common rotor-to-six-state relationship. Artificial intelligence multi-stator multi-function power, power generation motor system device. And in the outer three expansion stator coil group (106) and the outer four expansion stator coil group two stators (107) each of the stator rear connection line group additional selection switch (1101) in the power generation via the inner stator coil group full wave rectification automatic lifting pressure The controller (1201) is selected for charging and powering the external stator coil group brushless motor electronic shift controller (1301) to provide both driving functions. Therefore, the torque and power generation of the new expandable AI artificial intelligence multi-stator multi-function power and power generation motor system device can be adjusted and changed according to requirements. When high torque output is required, the outer two stator coil sets close to the circumference of the motor are preferred. The power supply drives the multi-layer common rotor to rotate, increasing the distance between the force application point and the fulcrum to collect the leverage principle. On the other hand, when a large power output is required or recharged to the battery, the multi-layer common rotor rotation is preferentially driven by the inner stator coil group (101) close to the axis, and the other outer stator coil group (102) and the outer stator coil group (103), the outer two stator coil group (104) power generation output through the outer stator coil group full-wave rectification automatic buck-boost controller (1202), the outer stator coil group full-wave rectification automatic buck-boost controller (1203), the outer two stator The coil group full-wave rectification automatic buck-boost controller (1204) charges the super capacitor group (1206) through the stator group parallel battery automatic charging controller (1205) and then recharges to the rechargeable battery pack (12) to receive the flywheel energy storage. At the same time, the mechanical energy loss of the gear unit due to the mechanical energy loss during the rotation is reduced, and the industrial use value of the expandable artificial intelligence multi-stator multi-function power generation motor system device has been increased.

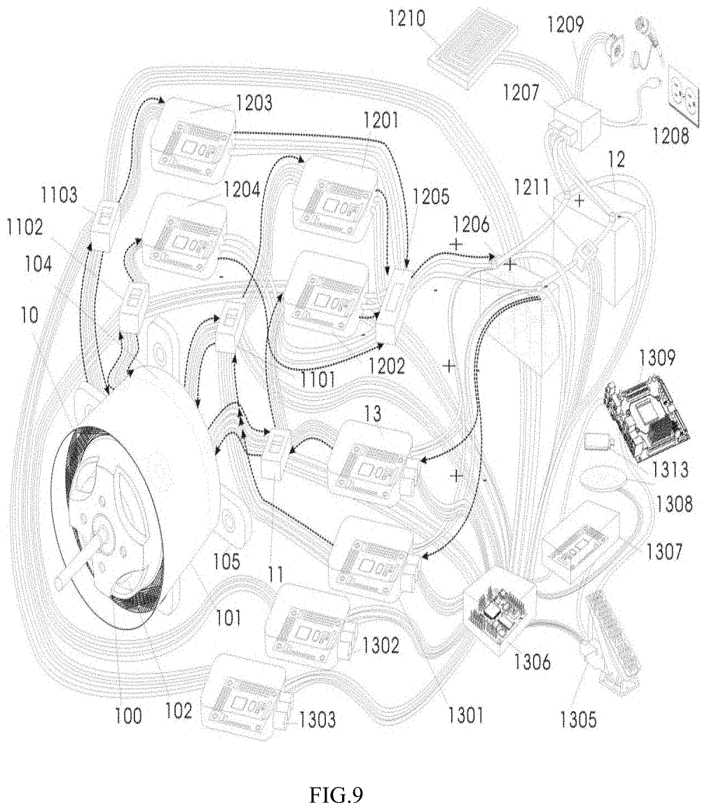

Please refer to FIG. 9, the expandable AI artificial intelligence power, power generation multi-stator multi-function motor and system device of the preferred embodiment of the present invention, in order to meet the requirements of various usage scenarios, road conditions and loads. And fully utilize the 360-degree omnidirectional magnetic field of the multi-layer common rotor (100), and the inner stator coil group (101) and the outer stator coil group (102) and the outer stator coil group (103) and the outer two stator coil group (104) The driving and power generation mode, therefore, in the AI artificial intelligence power, power generation multi-stator multi-function motor, the stator coil group (101) and the outer stator coil group (102) outside the stator coil group (103) and the outer two stator coil group (104) Each of the power lines is provided with a set of inner stator coil group selection switch (11), an outer stator coil group selection switch (1101) outside a certain sub coil group selection switch (1102), and an outer two stator coil group selection switch (1103) It can select different functions according to the needs in different situations and terminal applications. For example, when it is applied to electric steam or locomotive, it needs a large horsepower when starting, so it can be set automatically at the start. The inner stator coil assembly (101) selects the inner stator coil group brushless motor electronic shift controller (13) power supply drive and the outer stator coil group (102) via the outer stator coil group via the inner stator coil group wire group selection switch (11). The switch (1101) selects the outer stator coil group brushless motor electronic shift controller (1301) to supply power, since the inner and outer stators select the combination of the brushless motor electronic shift controller power supply drive, and simultaneously the multilayer common rotor (100) Pushing in the same direction to obtain a larger output torque when the steam locomotive starts, so the starting acceleration is faster, and after accelerating to a constant speed, the outer stator coil group (102) is surrounded by the inner magnetic field of the inner layer (1004) of the multi-layer common rotor. And the multi-layer common rotor outer layer (1003) is cut and transformed by the outer fixed coil group (103) and the outer two stator coil group (104), and the outer stator coil (102) and the outer stator coil group (103) and the outer two The stator coil group (104) simultaneously generates electric energy (generated by mechanical energy/kinetic energy) and then passes through the outer stator power line (1023) and the outer stator power line (1033). And the external two stator power line (1043) output AC current to the full-wave rectification automatic buck-boost controller (1201) and the wave rectification automatic buck-boost controller (1202) and the wave rectification automatic buck-boost controller (1203) for AC and DC The conversion and output stable DC power is connected in parallel to the battery automatic charge controller (1205). The super capacitor group (1206) can quickly absorb the large amount of DC power by the super capacitor, and rectify the power generating stator group into DC power for absorption and storage. The super capacitor battery automatic charging controller (1211) then charges and stores the battery (12), that is, the side charging mode. If the battery power is exhausted, the driver can pass the AC to DC/DC. The variable voltage power conversion automatic charging controller (1207) charges the vehicle battery in various ways, such as 1. At home, home 110V AC power charging line set (1208), 2. Electric vehicle dedicated 48V DC fast charge battery automatic charging seat (1209), 3. Charge the battery directly with the wireless charger of the car with the wireless charging power receiving board (1210); and (11) the stator coil group wire group selection switch and (1101) outer stator coil group wire group selection switch and (1102) outer stator coil group wire group selection switch and (1103) outer two stator coil group All the stator group selection switch positions, such as the line group selection switch, are applied according to different driving road conditions and phase definitions, such as high torque power supply output mountain climbing mode or off-road four-wheel drive mode during mountain climbing, and urban stop-and-go plane road mode power supply, power generation balance mode, long-term high-speed low-torque flywheel power generation back-up mode, simple-action generator mode, etc., the servo system software program is written in various road conditions, driving stages, output torque, power generation After the vehicle starts to smash, the corresponding software execution code of the normal endurance driving mode is automatically executed to execute the database action group information, and the automatic navigation module (1307) according to the coordinates of the departure point to the destination after the driver inputs the destination address. The position coordinates are used for path path planning and 3D road gradient, and the 4G module (1313) obtains real-time traffic information analysis via the network. The driving route is automatically carried out by the driving computer (1309) after the driver confirms and automatically detects the driving route. The road condition, the slope, the torque provided by the different stator combinations, and the power generation amount in the path are automatically developed. The task allocation table of each stator group is executed according to the current satellite coordinate position of the GPS satellite receiver (1308) and each stator of the expected arrival location, and the driving computer (1309) is automatically notified in advance, and is 32-bit 32-channel. The multi-channel servo steering control module (1306) performs the stator coil group line group selection switch in the multi-function selection switch (11) of all the stator groups, and the (1101) outer stator coil group line group selection switch, and (1102) Sub-coil group line group selection switch, (1103) outer two stator coil group line group selection switch driving mode combination, and with the driver's expandable AI artificial intelligence power, power generation multi-stator multi-function horse speed control throttle (1305) The control, in addition to the kinetic energy generated by the electric energy, can also transport the multi-layer common rotor near the circumference of the motor, the circumference is long, so the permanent magnet or the exciting magnet has more magnetic poles. The energy effect and the winding volume of the stator group around the periphery of the motor are large, so the power generation can be generated more quickly and can be stored and recycled. At the same time, the AI artificial intelligence is used to improve the degree of automatic control and simplify the complexity of human operation. To meet the needs of different use scenarios, road conditions and loads, to enhance the industrial use value of this creation.

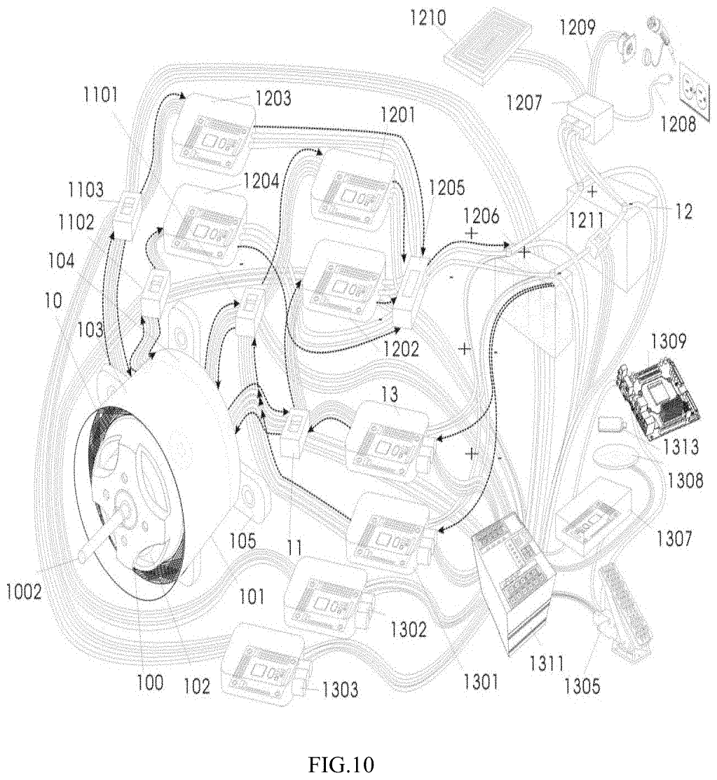

Please refer to the FIG. 10, the expandable AI artificial intelligence power, power generation multi-stator multi-function motor and system device of the preferred embodiment of the present invention, in order to meet the requirements of various usage scenarios, road conditions and loads. And fully utilize the 360-degree omnidirectional magnetic field of the multi-layer common rotor (100), and the inner stator coil group (101) and the outer stator coil group (102) and the outer stator coil group (103) and the outer two stator coil group (104) The driving and power generation mode, therefore, in the AI artificial intelligence power, power generation multi-stator multi-function motor, the stator coil group (101) and the outer stator coil group (102) outside the stator coil group (103) and the outer two stator coil group (104) Each of the power lines is provided with a set of inner stator coil group selection switch (11), an outer stator coil group selection switch (1101) outside a certain sub coil group selection switch (1102), and an outer two stator coil group selection switch (1103) in different situations and terminal applications, different modes can be selected according to requirements. For example, when applied to electric steam or locomotive, a large horsepower is required for starting, so it can be automatically set to enter when starting. The inner stator coil assembly (101) selects the inner stator coil group brushless motor electronic shift controller (13) power supply drive and the outer stator coil group (102) via the outer stator coil group via the inner stator coil group wire group selection switch (11). The switch (1101) selects the outer stator coil group brushless motor electronic shift controller (1301) to supply power, since the inner and outer stators select the combination of the brushless motor electronic shift controller power supply drive, and simultaneously the multilayer common rotor (100) pushing in the same direction to obtain a larger output horsepower when the steam locomotive starts, so the starting acceleration is faster, and after accelerating to a constant speed, the outer stator coil group (102) is surrounded by the inner magnetic field of the inner layer (1004) of the multi-layer common rotor. And the multi-layer common rotor outer layer (1003) is cut and transformed by the outer fixed coil group (103) and the outer two stator coil group (104), and the outer stator coil (102) and the outer stator coil group (103) and the outer two The stator coil group (104) recovers and generates electric energy (generated by mechanical energy/kinetic energy) and then passes through the outer stator power line (1023) and the outer stator power line (1033). And the external two stator power line (1043) output AC current to the full-wave rectification automatic buck-boost controller (1201) and the wave rectification automatic buck-boost controller (1202) and the wave rectification automatic buck-boost controller (1203) for AC and DC The conversion and output stable DC power is connected in parallel to the battery automatic charge controller (1205). The super capacitor group (1206) can quickly absorb the large amount of DC power by the super capacitor, and rectify the power generating stator group into DC power for absorption and storage. The super capacitor battery automatic charging controller (1211) then charges and stores the battery (12), that is, the side charging mode, when the battery power is used up, the driver can pass the AC to DC/DC voltage conversion power supply. The conversion automatic charge controller (1207) charges the vehicle battery in a variety of ways, such as 1. With household AC power charging line set (1208), 2. DC charging battery automatic charging stand (1209), 3. Wireless charging power receiving board (1210) directly charging the battery. And (11) the stator coil group wire group selection switch and (1101) outer stator coil group wire group selection switch in this mode, and (1102) outer stator coil group line group selection switch and (1103) outer two stator coil group line group selection switch, etc. All stator group selection switch positions are selected according to different driving road conditions and stage definitions, such as high torque during mountain climbing. Power supply output mountaineering mode or off-road four-wheel drive mode, urban stop-and-go plane road mode power supply, power generation balance mode, long-term high-speed low-torque flywheel power generation back-flight mode, purely mobile generator mode, etc. The PLC executable program software program is used to write the software execution code of various normal road conditions, driving stages, output torque, power generation, etc., and the normal endurance driving mode after the vehicle starts, according to the driver's input destination address, the automatic navigation mode Group (1307) According to the coordinates of the coordinates of the starting point to the destination, the path planning and 3D road gradient are used. The 4G module (1313) obtains the real-time traffic information analysis via the network and then recommends the driving route. The driver confirms the driving route. After the driving computer (1309), the road is automatically unfolded, and the road conditions, slopes, and gradations of different road sections are not The task allocation table of each stator group in the torque and power generation deployment paths provided by the stator combination is automatically executed by each stator group according to the current and expected arrival of the GPS satellite receiver (1308), and simultaneously The PLC programmable logic controller module (1311) performs the stator coil group line group selection switch in the multi-function selection switch (11) of all the stator groups, and the (1101) outer stator coil group line group selection switch, (1102) Sub-coil group line group selection switch, (1103) outer two stator coil group line group selection switch driving mode combination, and with the driver's expandable AI artificial intelligence power, power generation multi-stator multi-function horse speed control throttle (1305) The control, in addition to the kinetic energy generated by the electric energy, can also transport the multi-layer common rotor near the circumference of the motor, the circumference is long, so the permanent magnet or the field magnet has more magnetic poles and the surrounding stator assembly The winding volume is large, so the power generation can be generated more quickly, and can be quickly stored and recycled. At the same time, AI artificial intelligence is used to improve the degree of automatic control and simplify the complexity of human operation. To meet the needs of different use situations, road conditions and loads, to enhance the industrial use value of this creation.

Please refer to the eleventh figure, the scalable AI artificial intelligence power, power generation multi-stator multi-function motor and system device of the preferred embodiment of the present invention, in order to meet various usage scenarios, loads and power generation. The need to make full use of the 360-degree omnidirectional magnetic field of the multilayer common rotor (100), and the inner stator coil assembly (101) and the outer stator coil assembly (102) and the outer stator coil assembly (103) and the outer two stator coil assembly (104) The driving and power generation mode, therefore, in the AI artificial intelligence power, power generation multi-stator multi-function motor, the stator coil group (101) and the outer stator coil group (102) outside the stator coil group (103) and the outer two stator coils A set of inner stator coil group selection switch (11), an outer stator coil group selection switch (1101) external sub coil group selection switch (1102), and an outer two stator coil group selection switch (1) are respectively disposed on the power line of the group (104). 1103), wherein the outer two stator coil group selection switch (1103) can be connected between an outer two stator coil group full-wave rectification automatic buck-boost controller (1204) and an alternating current transformer (1104) In other words, according to necessity by the different situations and different end application selection mode, for example, is applied to the generator; 1. Below 4000 W AC output mode: For household power supply, when the battery power is output from DC to AC power converter (1214) in a single source, that is, the total power supply is less than 4000 W DC to AC power conversion. When the AC output power of the load (1214) is supplied to the stator coil group of the stator coil group, the electronic shift controller (13) generates a magnetic field from the inner stator coil group (101) to drive the multi-layer common rotor rotation (100). The other outer stator coil group (102) and the outer stator coil group (103) and the outer two stator coil group (104) are rotated by the multi-layer common rotor, and the alternating current is generated by the magnetic field line transformation, and then the outer stator coil group is generated. Full-wave rectification automatic buck-boost controller (1202), external sub-coil group full-wave rectification automatic buck-boost controller (1203), external two-stator coil set full-wave rectification automatic buck-boost controller (1204) output specific voltage, parallel After that, a large amount of DC power is retained by the super capacitor group (1206), and then the battery is charged, and the 110V AC power converter is used to output 110V AC power suitable for home appliances; 2. More than 4000 W AC output mode: the dual source of maximum power supply, in addition to the battery power from the 4000 W DC to AC power converter (1214) load AC output, plus the outer two stator coil set (104). Due to the high winding volume and large volume of the stator set, the AC power generation is large at the same speed, and the AC power is directly transformed to the voltage output suitable for the household appliance, and the AC power supply is added. Supplying power to the stator coil group of the stator coil group, the electronic shifting controller (13) generates a magnetic field from the inner stator coil assembly (101), drives the multilayer common rotor rotation (100), and the other outer stator coil assembly (102) and The outer stator coil group (103) and the outer two stator coil group (104) are rotated by the multi-layer common rotor, and the alternating current is generated by the magnetic field line transformation, and then the full-wave rectification automatic lifting and lowering controller (1202) is performed through the outer stator coil group. The external sub-coil group full-wave rectification automatic step-up and step-down controller (1203) outputs a specific voltage. After the parallel connection, the high-capacity group (1206) is used to retain a large amount of DC power, and then the battery is charged, and the AC power is transmitted through 4000 W DC. The converter (1214) outputs 110V AC power suitable for use in home appliances. In addition, the multi-layer common rotor (100) is close to the circumference and has a large amount of power generated by the outer two stator coil sets (104). The alternating current generated by the stator is adjusted to 110V by the alternating current transformer (1104), and the 60 Hz AC power output is directly given to The use of household appliances, plus the DC power supply of the battery through the 4000 watt DC to AC power converter (1214) for household appliances, so the AC output directly through the transformer plus 4000 watts DC to AC power converter output the combined maximum AC output generator mode, if the battery power is used up, it can be converted to the household AC power charging line group (1208) through the AC to DC/DC transformer power supply to charge the battery (1208) to directly charge the battery to supplement the lost power. Mode (11) stator coil group line group selection switch and (1101) outer stator coil group line group selection switch and (1102) outer stator coil group line group selection switch and (1103) outer two stator coil group line group selection All stator group selection switch positions such as switches are selected according to different conditions and stage definitions, such as simple generator mode, maximum AC power supply mode, etc., and the servo program controller software program is written in various situations, output torque, power generation, etc. The software executes the program code, and according to the input target power generation target mode, the programmable command control panel (1312) automatically expands the task allocation table of each stator group in the torque and power generation expansion paths provided by the different stator combinations according to the target. At the same time, the 32-bit 32-channel multi-channel servo steering control module (1306) performs the stator coil assembly line of the multi-function selector switch (11) of all stator sets. Selection switch, (1101) outer stator coil group wire group selection switch, (1102) outer stator coil group wire group selection switch, (1103) outer two stator coil group wire group selection switch execution mode combination, and automatic detection The control, in addition to the kinetic energy generated by the electric energy, can also be used to transport the multi-layer common rotor near the circumference of the motor, the circumference is long, so the permanent magnet or the field magnet has more magnetic poles and the outer stator circumference winding The wire volume is large, so the power generation can be generated more quickly, and the system can automatically adjust the regenerative AI artificial intelligence power generation multi-stator multi-function motor system device speed according to the power consumption and battery voltage. Balance the purpose of power output. Therefore, the new type of electric vehicle with the expandable AI artificial intelligence power generation multi-stator multi-function motor system can become a small mobile power station when going out for camping and office work. When returning to the underground parking lot, it can be transmitted via the power transmission system. Electricity is transferred from the underground parking lot to the home for use by other household appliances to achieve special functions of energy saving and carbon reduction. At the same time, AI artificial intelligence is used to improve the degree of automatic control, simplifying the complexity of human operation to meet the needs of different usage scenarios, power generation targets and loads, and enhance the industrial utilization value of this creation.

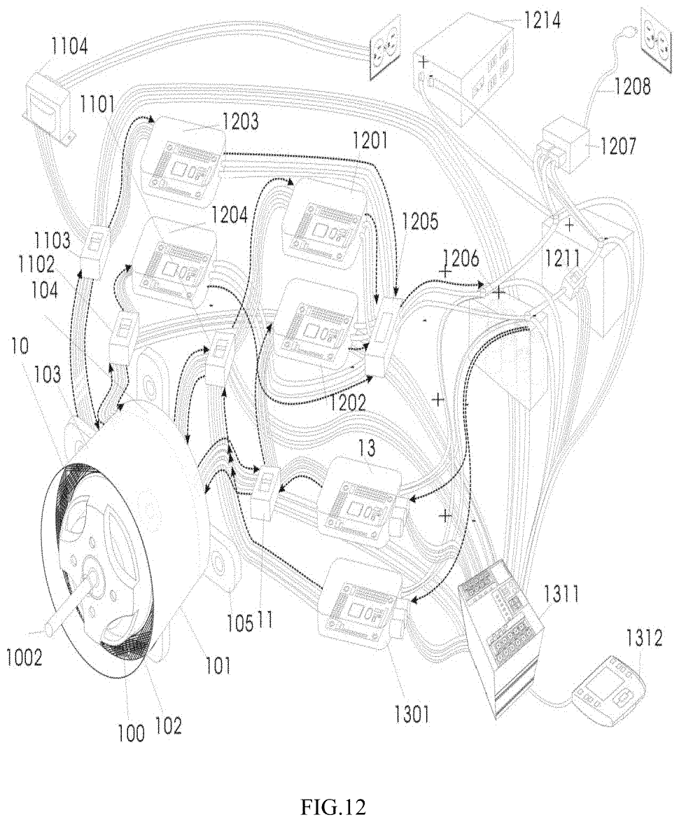

Please refer to FIG. 12, the expandable AI artificial intelligence power, power generation multi-stator multi-function motor and system device of the preferred embodiment of the present invention are in accordance with various usage scenarios, loads and power generation. The need to make full use of the 360-degree omnidirectional magnetic field of the multilayer common rotor (100), and the inner stator coil assembly (101) and the outer stator coil assembly (102) and the outer stator coil assembly (103) and the outer two stator coil assembly (104) The driving and power generation mode, therefore, in the AI artificial intelligence power, power generation multi-stator multi-function motor, the stator coil group (101) and the outer stator coil group (102) outside the stator coil group (103) and the outer two stator coils A set of inner stator coil group selection switch (11), an outer stator coil group selection switch (1101) external sub coil group selection switch (1102), and an outer two stator coil group selection switch (1) are respectively disposed on the power line of the group (104). 1103), wherein the outer two stator coil group selection switch (1103) can be connected between an outer two stator coil group full-wave rectification automatic buck-boost controller (1204) and an alternating current transformer (1104) In other words, according to necessity by the different situations and different end application selection mode, for example, is applied to the generator, 1. Below 4000 W AC output mode: For household power supply, when the battery power is output from DC to AC power converter (1214) in a single source, that is, the total power supply is less than 4000 W DC to AC power conversion. When the AC output power of the load (1214) is supplied to the stator coil group of the stator coil group, the electronic shift controller (13) generates a magnetic field from the inner stator coil group (101) to drive the multi-layer common rotor rotation (100). The other outer stator coil group (102) and the outer stator coil group (103) and the outer two stator coil group (104) are rotated by the multi-layer common rotor, and the alternating current is generated by the magnetic field line transformation, and then the outer stator coil group is generated. Full-wave rectification automatic buck-boost controller (1202), external sub-coil group full-wave rectification automatic buck-boost controller (1203), external two-stator coil set full-wave rectification automatic buck-boost controller (1204) output specific voltage, parallel After that, a large amount of DC power is retained by the super capacitor group (1206), and then the battery is charged, and the 110V AC power converter is used to output 110V AC power suitable for home appliances. 2. More than 4000 W AC output mode: the dual source of maximum power supply, in addition to the battery power from the 4000 W DC to AC power converter (1214) load AC output, plus the outer two stator coil set (104). Due to the high winding volume and large volume of the stator set, the AC power generation is large at the same speed, and the AC power is directly transformed to the voltage output suitable for the household appliance, and the AC power supply is added. Supplying power to the stator coil group of the stator coil group, the electronic shifting controller (13) generates a magnetic field from the inner stator coil assembly (101), drives the multilayer common rotor rotation (100), and the other outer stator coil assembly (102) and The outer stator coil group (103) and the outer two stator coil group (104) are rotated by the multi-layer common rotor, and the alternating current is generated by the magnetic field line transformation, and then the full-wave rectification automatic lifting and lowering controller (1202) is performed through the outer stator coil group. The external sub-coil group full-wave rectification automatic step-up and step-down controller (1203) outputs a specific voltage. After the parallel connection, the high-capacity group (1206) is used to retain a large amount of DC power, and then the battery is charged, and the AC power is transmitted through 4000 W DC. The converter (1214) outputs 110V AC power suitable for use in home appliances. In addition, the multi-layer common rotor (100) is close to the circumference and has a large amount of power generated by the outer two stator coil sets (104). The alternating current generated by the stator is adjusted to 110V by the alternating current transformer (1104), and the 60 Hz AC power output is directly given to The use of household appliances, plus the DC power supply of the battery through the 4000 watt DC to AC power converter (1214) for household appliances, so the AC output directly through the transformer plus 4000 watts DC to AC power converter output The combined maximum AC output generator mode, if the battery power is used up, it can be converted to the household AC power charging line group (1208) through the AC to DC/DC transformer power supply to charge the battery (1208) to directly charge the battery to supplement the lost power. Mode (11) stator coil group line group selection switch and (1101) outer stator coil group line group selection switch and (1102) outer stator coil group line group selection switch and (1103) outer two stator coil group line group selection All stator group selection switch positions such as switches are selected according to different conditions and stage definitions, such as simple generator mode and maximum AC power supply mode. PLC programmable logic control software program is used to write various situations, output torque and power generation. The software executes the program code, and according to the input target power generation target mode, the programmable command control panel (1312) automatically expands the task allocation table of each stator group in the torque and power generation expansion paths provided by the different stator combinations according to the target. At the same time, the PLC programmable logic controller module (1311) performs the stator coil group line group selection in the multi-function selector switch (11) of all stator groups. Switch, (1101) outer stator coil group line group selection switch, (1102) outer stator coil group line group selection switch, (1103) outer two stator coil group line group selection switch execution mode combination, and with automatic detection Control, in addition to the kinetic energy generated by electric energy, it can also transport the multi-layer common rotor near the circumference of the motor, the circumference is long, so the permanent magnet or the field magnet has more magnetic poles and the surrounding motor stator winding Larger volume, so more power generation can be generated for rapid storage and recycling. The system can automatically adjust the speed of the expandable AI artificial intelligence power generation multi-stator multi-function motor system based on power consumption and battery voltage to achieve balance. The purpose of power output. Therefore, the new type of electric vehicle with the expandable AI artificial intelligence power generation multi-stator multi-function motor system can become a small mobile power station when going out for camping and office work. When returning to the underground parking lot, it can be transmitted via the power transmission system. Electricity is transferred from the underground parking lot to the home for use by other household appliances to achieve special functions of energy saving and carbon reduction. At the same time, AI artificial intelligence is used to improve the degree of automatic control, simplifying the complexity of human operation to meet the needs of different usage scenarios, power generation targets and loads, and enhance the industrial utilization value of this creation.

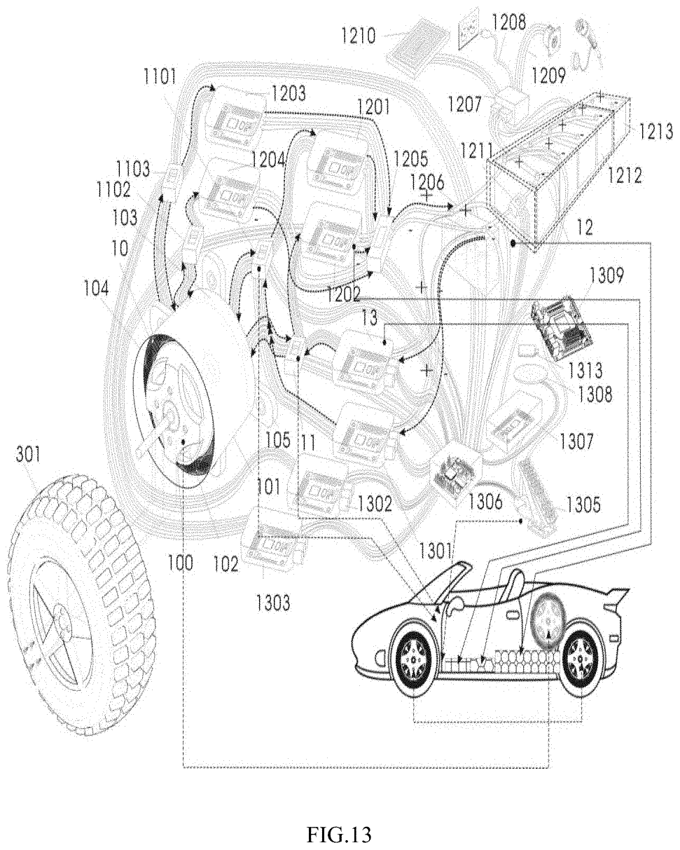

Please refer to FIG. 13, the scalable AI artificial intelligence power, power generation multi-stator multi-function motor and system device preferably implemented in the present invention, the expandable AI artificial intelligence power of the preferred embodiment of the present invention Multi-stator multi-function motor and system device for power generation, in order to meet the needs of various different use scenarios, road conditions and loads, and make full use of the 360-degree omnidirectional magnetic field of the multi-layer common rotor (100), and the inner stator coil group (101) and outside The stator coil group (102) and the outer stator coil group (103) and the outer two stator coil group (104) are driven and generated by the stator coil group (101), especially in the AI artificial intelligence power, power generation multi-stator multi-function motor. And a set of inner stator coil group selection switch (11) and outer stator coil group selection switch are respectively disposed on the power lines of the outer stator coil group (102) and the outer two stator coil group (104). (1101) outer stator coil group selection switch (1102), outer two stator coil group selection switch (1103) can select different functions according to requirements in different situations and terminal applications For example, when applied to electric steam or locomotive, a large horsepower is required for starting, so the inner stator coil group (101) can be automatically set at the start to select the inner stator coil group via the inner stator coil group wire group selection switch (11). Brush motor electronic shift controller (13) power supply drive and outer stator coil set (102) select external stator coil set brushless motor electronic shift controller (1301) powered by external stator wire set selector switch (1101), due to internal and external The stator selects the combination of the power supply drive of the brushless motor electronic shift controller, and simultaneously pushes the multi-layer common rotor (100) in the same direction to obtain a larger output torque when the steam locomotive starts, so the starting acceleration is faster, to be accelerated After a certain speed, the outer stator coil group (102) and the multi-layer common rotor outer layer (1003) are externally fixed to the outer coil group (103) and the outer two stator coil group (104). The continuous cutting and transformation of the magnetic lines of force, the outer stator coil (102) and the outer stator coil group (103) and the outer two stator coil group (104) Simultaneously generate electric energy (generated by mechanical energy/kinetic energy) and then output AC current to the full-wave rectification automatic buck-boost via the outer stator power line (1023), the outer stator power line (1033) and the outer two stator power line (1043). The controller (1201) and the full-wave rectification automatic buck-boost controller (1202) and the full-wave rectification automatic buck-boost controller (1203) perform AC-DC conversion and output stable DC power, which is located in the four tire wheel frames of the car. The function selection switch combination in the expandable AI artificial intelligence power and power generation multi-stator multi-function motor is defined as the pure multi-stator generator state in which the driving force is provided by the core power motor and the mechanical kinetic energy is output to the transmission system to drive the tire to passively rotate. The multi-stator generator rotates the multi-layer common rotor (100) tire by external force, and the magnetic force line simultaneously cuts the inner stator coil group (101) and the outer stator coil group (102) in the multi-stator multi-function motor of the tire wheel frame to generate alternating current, Inner stator coil group (101) inner stator coil group wire group selection switch (11) and outer stator coil group (102) outer stator coil group wire group The selection switch (1101) selects the inner stator coil group full-wave rectification automatic buck-boost controller (1201) and the outer stator coil group full-wave rectification automatic buck-boost controller (1202), and rectifies the generated alternating current to full-wave to DC After a specific voltage is connected in parallel to the battery automatic charging controller (1205), the super capacitor group (1206) can quickly absorb a large amount of direct current characteristics by the super capacitor, and the power generating stator group is rectified into a direct current and then absorbed and stored through the super capacitor. The battery automatic charging controller (1211) performs charging storage and recycling for the series driving 48V battery pack (1212) for vehicle driving power and 12V battery pack (1213) for vehicle electrical equipment, that is, the side charging mode. If the battery is running out of power, the driver can use the AC to DC/DC transformer power supply to switch the automatic charge controller (1207) to charge the vehicle battery in a variety of ways, such as 1. at home, home 110V AC power charging line set (1208), 2. Electric vehicle dedicated 48V DC fast charge battery automatic charging seat (1209), 3. Charge the battery directly with the wireless charger of the car with the wireless charging power receiving board (1210). And (11) the stator coil group wire group selection switch and (1101) outer stator coil group wire group selection switch and (1102) outer stator coil group wire group selection switch and (1103) outer two stator coil group All the stator group selection switch positions, such as the line group selection switch, are applied according to different driving road conditions and phase definitions, such as high torque power supply output mountain climbing mode or off-road four-wheel drive mode during mountain climbing, and urban stop-and-go plane road mode power supply, power generation balance mode, long-term high-speed low-torque flywheel power generation back-up mode, simple-action generator mode, etc., the servo system software program is written in various road conditions, driving stages, output torque, power generation After the vehicle starts to smash, the corresponding software execution code of the normal endurance driving mode is automatically executed to execute the database action group information, and the automatic navigation module (1307) according to the coordinates of the departure point to the destination after the driver inputs the destination address. The position coordinates are used for path path planning and 3D road gradient, and the 4G module (1313) obtains real-time traffic information analysis via the network. The driving route is automatically carried out by the driving computer (1309) after the driver confirms and automatically detects the driving route. The road condition, the slope, the torque provided by the different stator combinations, and the power generation amount in the path are automatically developed. The task allocation table of each stator group is executed according to the current satellite coordinate position of the GPS satellite receiver (1308) and each stator of the expected arrival location, and the driving computer (1309) is automatically notified in advance, and is 32-bit 32-channel. The multi-channel servo steering control module (1306) performs the stator coil group line group selection switch in the multi-function selection switch (11) of all the stator groups, and the (1101) outer stator coil group line group selection switch, and (1102) Sub-coil group line group selection switch, (1103) outer two stator coil group line group selection switch driving mode combination, and with the driver's expandable AI artificial intelligence power, power generation multi-stator multi-function horse speed control throttle (1305) The control, in addition to the kinetic energy generated by the electric energy, can also transport the multi-layer common rotor near the circumference of the motor, the circumference is long, so the permanent magnet or the exciting magnet has more magnetic poles. The energy effect and the winding volume of the stator group around the periphery of the motor are large, so the power generation can be generated more quickly and can be stored and recycled. At the same time, the AI artificial intelligence is used to improve the degree of automatic control and simplify the complexity of human operation. To meet the needs of different use scenarios, road conditions and loads, to enhance the industrial use value of this creation.

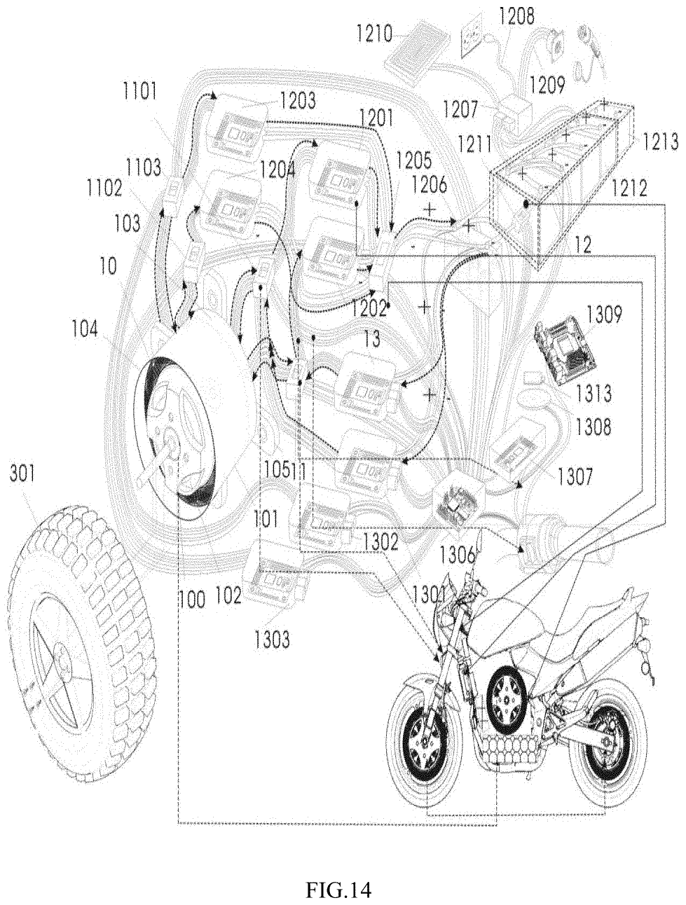

Please refer to FIG. 14, the scalable AI artificial intelligence power, power generation multi-stator multi-function motor and system device preferably implemented in the present invention, and the expandable AI artificial intelligence power of the preferred embodiment of the present invention. Multi-stator multi-function motor and system device for power generation, in order to meet the needs of various different use scenarios, road conditions and loads, and make full use of the 360-degree omnidirectional magnetic field of the multi-layer common rotor (100), and the inner stator coil group (101) and outside The stator coil group (102) and the outer stator coil group (103) and the outer two stator coil group (104) are driven and generated by the stator coil group (101), especially in the AI artificial intelligence power, power generation multi-stator multi-function motor. And a set of inner stator coil group selection switch (11) and outer stator coil group selection switch are respectively disposed on the power lines of the outer stator coil group (102) and the outer two stator coil group (104). (1101) outer stator coil group selection switch (1102), outer two stator coil group selection switch (1103) can select different functions according to requirements in different situations and terminal applications For example, when applied to a locomotive, a large horsepower is required for starting, so the inner stator coil group (101) can be automatically set at the start to select the inner stator coil group brushless motor electronic via the inner stator coil group wire group selection switch (11). The variable speed controller (13) power supply drive and the outer stator coil set (102) are powered by the outer stator set selection switch (1101) to select the outer stator coil set brushless motor electronic shift controller (1301), since both the inner and outer stators are selected. Brushless motor electronic shifting controller power supply drive combination, and simultaneously push the multi-layer common rotor (100) in the same direction, in order to obtain a large output torque when the locomotive starts, so the starting acceleration is faster, after acceleration to a specific speed By means of the inner magnetic field line of the inner layer (1004) of the multi-layer common rotor, the outer stator coil group (102) and the multi-layer common rotor outer layer (1003) are continuously connected to the outer sub coil group (103) and the outer two stator coil group (104). The cutting and transformation are simultaneously generated by the outer stator coil (102) and the outer stator coil group (103) and the outer two stator coil group (104). The electric energy (generated by the mechanical energy/kinetic energy) is then outputted to the full-wave rectification automatic buck-boost controller via the outer stator power line (1023), the outer stator power line (1033), and the outer two stator power line (1043). 1201) AC/DC conversion and output stable DC power with full-wave rectification automatic buck-boost controller (1202) and full-wave rectification automatic buck-boost controller (1203), which is expandable in two tire wheel frames of the locomotive AI artificial intelligence power, power generation multi-stator multi-function motor in the function selection switch combination is defined as the core power motor to provide vehicle driving force, output mechanical kinetic energy to the transmission system to drive the tire passive rotation of the pure multi-stator generator state and become a multi-stator The motor rotates the multi-layer common rotor (100) tire by external force, and the magnetic field line simultaneously cuts the inner stator coil group (101) and the outer stator coil group (102) in the multi-stator multi-function motor of the tire wheel frame to generate alternating current, and the inner stator coil The stator coil group wire group selection switch (11) and the outer stator coil group (102) outside the stator coil group wire group selection switch (1101) The internal stator coil set full-wave rectification automatic buck-boost controller (1201) and the outer stator coil group full-wave rectification automatic buck-boost controller (1202) are selected to rectify the generated alternating current to a specific voltage after full-wave rectification into direct current Parallel to the battery automatic charge controller (1205) to the super capacitor group (1206) by the super capacitor can quickly absorb a large number of direct current characteristics, the power generation stator group is rectified into DC power in parallel, after absorption and storage, and through the super capacitor battery automatic charge control The device (1211) performs charging storage and recycling for the series power 48V battery pack (1212) for the locomotive drive power and the 12V battery pack (1213) for the vehicle electrical equipment, that is, the side charging mode, if the battery is true when the power is exhausted, the driver can convert the auto battery through the AC to DC/DC converter power supply (1207). 1. At home, home 110V AC power charging line set (1208), 2. 48V DC fast charging battery automatic charging seat for electric motor car (1209), 3. Charge the battery directly with the wireless charger of the car with the wireless charging power receiving board (1210). And the mode (11) inner stator coil group wire group selection switch and (1101) outer stator coil group wire group selection switch and (1102) outer stator coil group wire group selection switch and (1103) outer two stator coil group All the stator group selection switch positions, such as the line group selection switch, are applied according to different driving road conditions and phase definitions, such as high torque power supply output mountain climbing mode or off-road two-wheel drive mode when climbing a mountain, urban stop-and-go plane road mode power supply, Power generation balance mode, long-time high-speed low-torque flywheel power generation back-up mode, simple-action generator mode, etc., the servo system software program is written in various road conditions, driving stages, output torque, power generation, etc. After the vehicle starts to smash, the corresponding software running code of the normal running mode is automatically executed to execute the database action group information. After the driver inputs the destination address, the automatic navigation module (1307) follows the coordinate position of the starting point to the destination. Position coordinates for path path planning and 3D road gradient and 4G module (1313) to obtain real-time traffic information analysis via network The driving route is automatically carried out by the driving computer (1309) after the driver confirms and automatically detects the driving route. The road condition, the slope, the torque provided by the different stator combinations, and the power generation amount in the path are automatically developed. The task allocation table of each stator group is executed according to the current satellite coordinate position of the GPS satellite receiver (1308) and each stator of the expected arrival location, and the driving computer (1309) is automatically notified in advance, and is 32-bit 32-channel. The multi-channel servo steering control module (1306) performs the stator coil group line group selection switch in the multi-function selection switch (11) of all the stator groups, and the (1101) outer stator coil group line group selection switch, and (1102) Sub-coil group line group selection switch, (1103) outer two-stator coil group line group selection switch driving mode combination, and with the driver's expandable AI artificial intelligence power, power generation multi-stator multi-function horse speed handle type locomotive throttle The control of the controller (1310), in addition to the kinetic energy generated by the electric energy, can also transport the multi-layer common rotor near the circumference of the motor, the circumference is long, and therefore the permanent magnet or the field magnet A very large number of flywheel energy storage effects and a large winding volume of the stator group around the periphery of the motor are relatively large, so that more power generation can be generated, which can be quickly stored and recycled, and the degree of automatic control is improved by AI artificial intelligence. Simplify the complexity of human operations to meet the needs of different usage scenarios, road conditions and loads, and enhance the industrial use value of this creation.

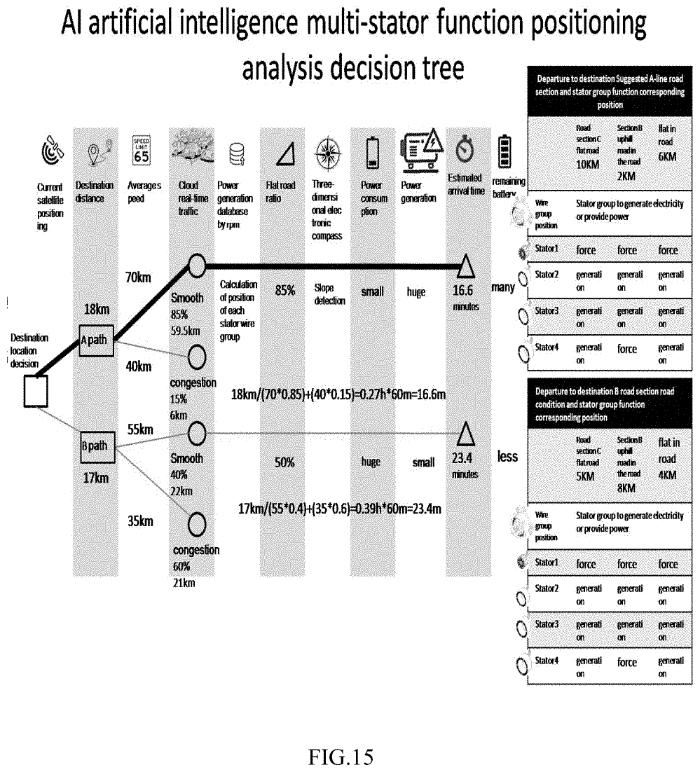

Please refer to FIG. 15, the scalable AI artificial intelligence power, power generation multi-stator multi-function motor and system device preferably implemented in the present invention, and the expandable AI artificial intelligence power of the preferred embodiment of the present invention The multi-stator multi-function motor and system device for power generation, in order to enable the system to use the 4G network (1313) and the GPS receiver (1308) to obtain relevant driving information in advance, and to plan the driving route in advance by using the driving computer (1309). Efficiently assign multi-stator function to select the best condition for generating or providing power to assist the driver to know ahead of time the road congestion situation and the measures such as the flat and mountain roads. Therefore, when the driver sets the destination location, the driving computer system (1309) The path planning can be carried out on the current satellite positioning coordinates and the destination coordinates of the vehicle, based on the road speed limit and the total distance of the road section, and then the driving computer (1309) automatically intercepts different suggested paths through the Internet. In the middle, all the roads are congested or smooth, and the immediate road conditions are analyzed to smooth the priority, and at the same time, different routes are adopted. The 3D slope degree of the segment is based on the vehicle load and the power consumption database combined with the three-dimensional electronic compass (1326) for real-time slope detection and analysis. The flat road section has a high proportion, the power consumption is small, and the power generation is larger. Priority, and the selection path with short time to reach the estimated destination and more remaining power is the evaluation criterion. The expandable AI artificial intelligence power, multi-stator multi-motor and power system are recommended to the driver. After the driver confirms by the system, the driving computer (1309) system automatically proposes the driving route to automatically expand the task assignment of each stator in the different road section coordinate point multi-stator function selection position, and according to the vehicle The position of the coordinates of the driving section and the 3D electronic compass (1326) are automatically detected by the instant detection. The AI artificial intelligence multi-stator function positioning analysis decision tree analysis tool is used to achieve advance planning, prediction, analysis, automatic execution and immediate correction to the destination. The best driving mode that saves time and energy.

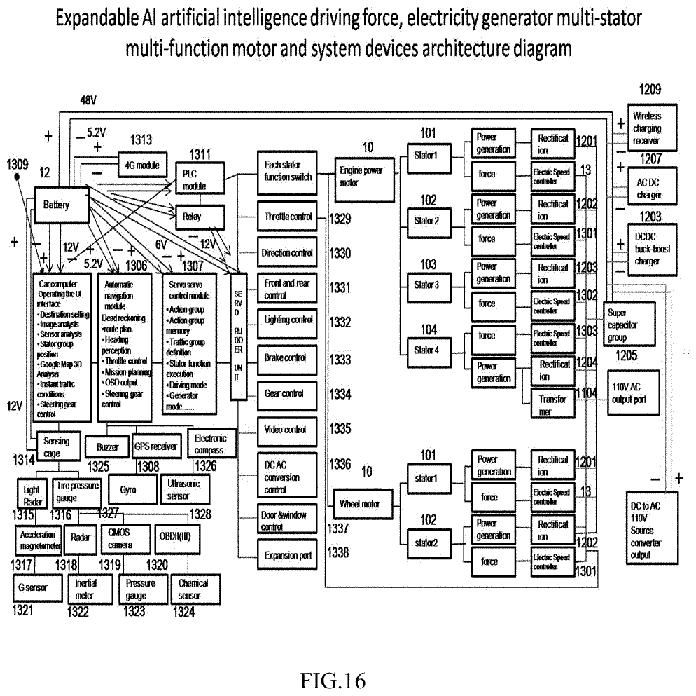

Please refer to FIG. 16, the scalable AI artificial intelligence power, power generation multi-stator multi-function motor and system device preferably implemented in the present invention, and the expandable AI artificial intelligence power of the preferred embodiment of the present invention The multi-stator multi-function motor and system device for power generation, for the application of the driving computer (1309) and the automatic navigation module and the 4G network (1313), the navigation route from the departure place to the destination in advance. Analysis of options such as destination distance, road type, average speed, real-time traffic conditions in the cloud, power consumption, power generation, and flat road ratio. In order to estimate the time required to reach the destination and the remaining vehicle power after arriving at the destination, the shortest travel time and the most remaining power route are prioritized. As a result of the decision tree analysis, the driver is preferentially recommended.

After the driver confirms the driving route and according to the road type according to the recommended road path, the corresponding type of the multi-function switch of the stator line group is selected according to the road type. The automatic deployment route task automatic allocation table automatically performs the multi-stator multi-function stator line group selection switch action group combination of the road segment according to the 3D coordinates of the satellite positioning. During the vehicle travel, the driving computer (1309) can be directly controlled by the PLC programmable logic controller module (1311) or the 32-bit 32-channel multi-channel servo steering controller (1307) by the automatic navigation module (1306). In addition to the stator group function switching switch action group, the GPS receiver (1308) module of the automatic navigation module (1306), the electronic compass (1326), the gyroscope (1327), etc. can be operated to operate the throttle (1329), direction. (1330), front and rear (1331), light (1332), brake (1333), gear (1334), audio and video (1335), direct AC conversion control (1336), door and window control (1337), and expansion port (1338) and other types of control, and the automatic detection of optical radar (1315), tire pressure gauge (1316), accelerometer magnetometer (1317), radar (by 13309) connected to the driving computer (1309) 1318) and CMOS camera (1319), G Sensor (1321), inertial instrument (1322), pressure gauge (1323), chemical sensor (1324), ultrasonic sensor (1326) and other detection systems. Automatically scan the current situation of surrounding vehicles, and perform trend prediction analysis according to inertia and dynamics to remind the driver or take precautionary measures by buzzer (1325) before the path obstacles may affect, even enter the unmanned when necessary and urgent Automatic driving mode to achieve the purpose of AI artificial intelligence assisted driving.

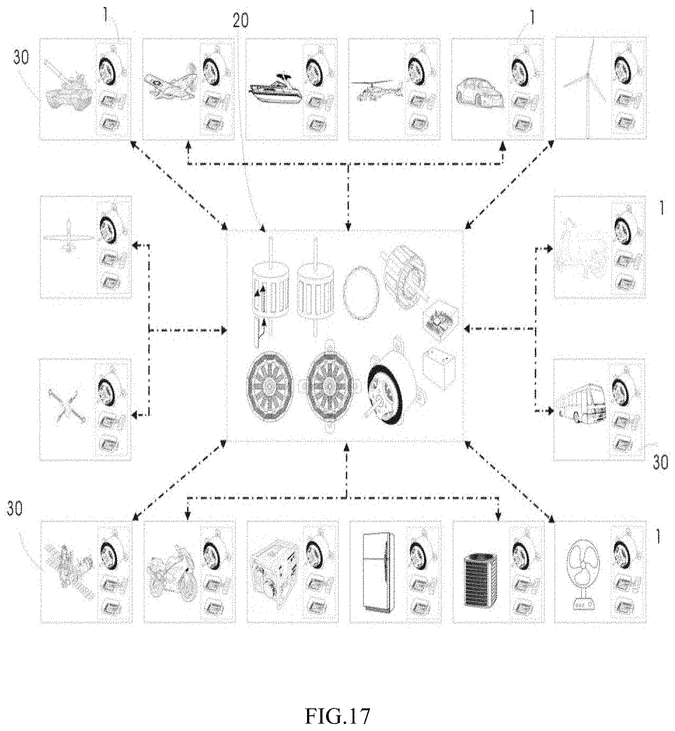

Please refer to FIG. 17, the terminal equipment and environment (30) of the industrial application field of this creation can be applied not only to the expandable AI artificial intelligence power, the power generation multi-stator multi-function motor and the system device (10). In addition to electric vehicles and locomotives, it is still possible to apply the multi-function multi-rotor multi-function external-rotating brushless motor system device (10) to various types of engines and gasoline-powered power sources according to the needs of users. General active vehicles, such as buses, electric bicycles, aircraft that have been thrust by propellers, helicopters, yachts, ships, unmanned reconnaissance aircraft, remotely piloted aircraft model aircraft, RC helicopters and multi-axis aircraft models, remote-controlled vehicle models, Remote control ship model, remote control car model and high-power air-conditioning, long-running refrigerators, electric fans and other household appliances, generators, wind turbines, generators for aviation space stations, etc., can be The terminal device of the application industry of the present invention (30); the system of electric power generation, that is, the battery (12) is connected to the brushless motor electronic shift controller (13) The power supply inner stator coil assembly (101) drives the multi-layer common rotor (100) to perform work to drive the electric re-running outer rotor coil assembly (102) of the vehicle to generate power (20) to achieve power consumption. The use of circulating power supply to generate and supplement electrical energy to reduce the consumption of natural energy oil and waste of power resources and effectively enhance the single-charge commuting use range of electric vehicles and save more cost benefits.

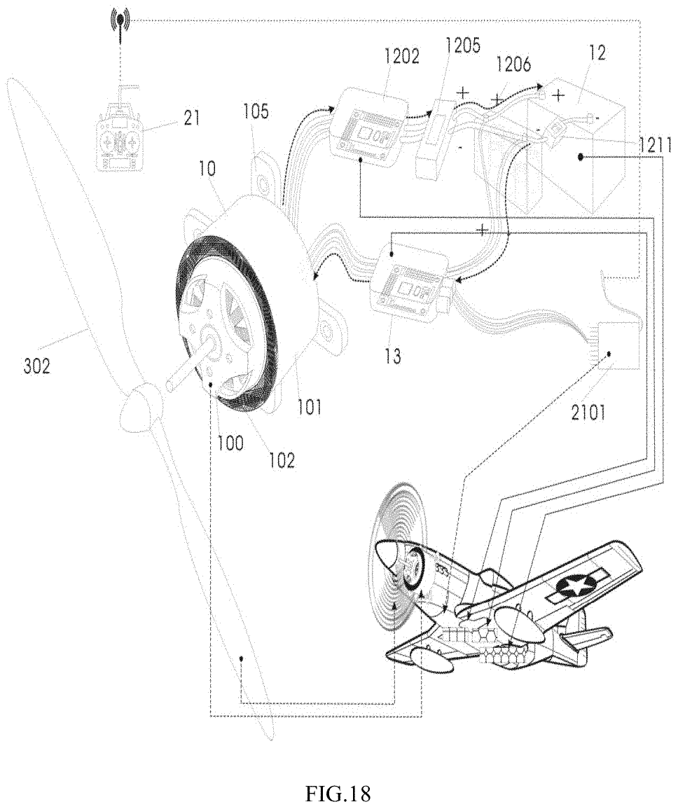

Referring to FIG. 18 again, the scalable AI artificial intelligence power, power generation multi-stator multi-function motor and system device of the preferred embodiment of the present invention is to fully utilize the 360 degree of the multi-layer common rotor (100). The omni-directional magnetic field line is connected to the brushless motor electronic shifting controller (13) via the inner stator coil assembly (101), and the RC wireless remote controller throttle controller (21) is received via the wireless signal receiver (2101). The adjustment is to control the rotation speed, drive the multi-layer common rotor (100) to move, the propeller (302) rotates at high speed to generate thrust, and the outer stator coil assembly (102) is connected to the rectification automatic lifting and lowering pressure controller (1202) via the outer stator coil assembly. After the AC power is rectified into a DC power by a full-wave rectification to a battery automatic charging controller (1205), the super capacitor group (1206) can quickly recombine the power generating stator group by the super capacitor capable of quickly absorbing a large amount of DC power. After the DC power is connected in parallel, the battery is immersed and stored, and the battery (12) is charged via the super capacitor battery automatic charging controller (1211). Storage and recycling, due to the higher the rotational speed of the multilayer common rotor (100), the greater the power consumption of the inner rotor coil assembly (101), the amount of power generated by the outer rotor coil assembly (102) and the recharge to the battery (12)) The power is also increased in equal proportions, so it can be extended to extend the flight time and distance of the remote control aircraft.

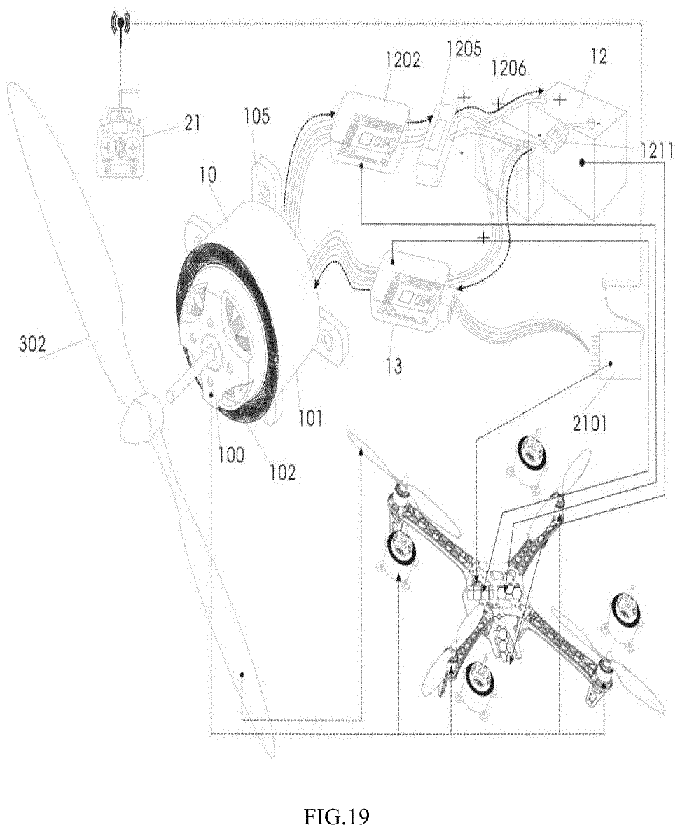

Please refer to FIG. 19, the extended AI artificial intelligence power and power generation multi-stator multi-function motor system which is preferably implemented in this creation is to fully utilize the 360-degree universal magnetic line of the multi-layer common rotor (100). Therefore, the inner stator coil group (101) is connected to the inner stator coil group brushless motor electronic shift controller (13) for power supply, and the wireless signal receiver (2101) is used to receive the RC wireless remote controller throttle controller of the multi-axis remote control aircraft. (21) The adjustment controls the rotation speed to drive the multi-layer common rotor (100) to move, so that the propeller (302) rotates at high speed to generate thrust, and the outer stator coil assembly (101) connects the outer stator coil group to the full wave via the outer stator coil assembly. The rectification automatic buck-boost controller (1202) rectifies the generated alternating current to full-wave and then parallels to a battery automatic charging controller (1205) to a super capacitor group (1206). The supercapacitor can quickly absorb a large amount of direct current. The characteristics of the generator stator group are rectified into DC power in parallel, absorbed and stored, and automatically charged via a super capacitor battery. The controller (1211) performs charging storage and recycling of the battery (12). Due to the higher the rotational speed of the multilayer common rotor (100), the larger the power consumption of the inner rotor coil assembly (101), the outer rotor coil assembly (The power generation of 102) and the amount of power recharged to the battery (12) are also increased, so that the flight time and the amplification distance of the multi-axis remote control aircraft can be extended.

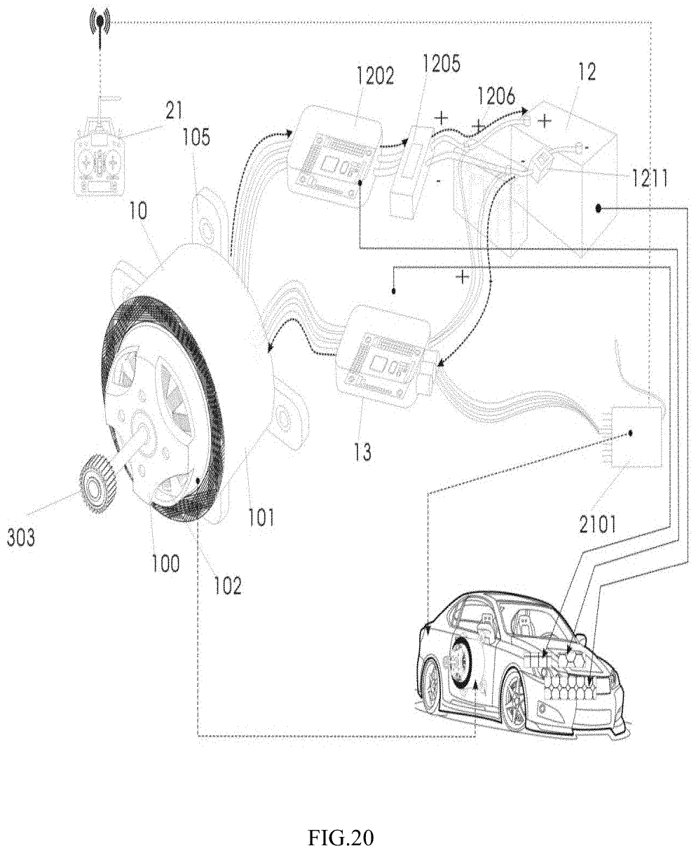

Please refer to FIG. 20, the extended AI artificial intelligence power and power generation multi-stator multi-function motor system which is preferably implemented in the present invention is to fully utilize the 360-degree universal magnetic line of the multi-layer common rotor (100). Therefore, the inner stator coil group (101) is connected to the inner stator coil group brushless motor electronic shift controller (13) for power supply, and the wireless signal receiver (2101) is received to receive the RC wireless remote controller throttle controller (21). The adjustment controls the rotation speed to drive the multi-layer common rotor (100) to move, so that the motor gear (303) rotates at high speed to generate power, and the outer stator coil assembly (101) connects the outer stator coil group to the full-wave rectification automatic lifting via the outer stator coil assembly. The voltage controller (1202) rectifies the generated alternating current into a direct current and then parallels the voltage to a battery automatic charging controller (1205). The super capacitor group (1206) can quickly absorb a large amount of direct current characteristics by the super capacitor. The power generating stator group is rectified into DC power in parallel and then absorbed and stored, and then passed through a super capacitor battery automatic charging controller (1211). The battery (12) is charged and stored and recycled. Since the multi-layer common rotor (100) has a higher rotational speed and the power consumption of the inner rotor coil group (101) is larger, the power generation amount of the outer rotor coil group (102) is The amount of power recharged to the battery (12) is also increased equally, so it can be extended to extend the driving time and the distance of the remote control car.

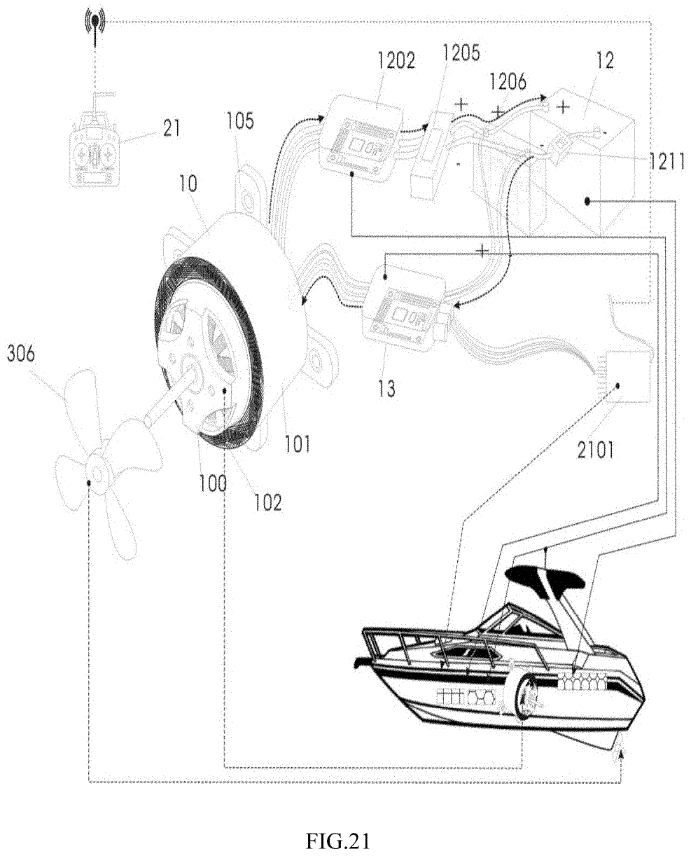

Please refer to FIG. 21, the extended AI artificial intelligence power, power generation multi-stator multi-function motor system system better implemented in this creation, in order to make full use of the 360-degree all-round of the multi-layer common rotor (100) The magnetic line is thus supplied via the inner stator coil assembly (101) to the inner stator coil group brushless motor electronic shift controller (13), and via the wireless signal receiver (2101) to accept the RC wireless remote control boat throttle controller (21) The adjustment is to control the speed of the rotation, drive the multi-layer common rotor (100) to move, so that the propeller (306) rotates at high speed to generate thrust, and the outer stator coil assembly (101) is connected to the outer stator coil assembly via the outer stator coil assembly. The buck-boost controller (1202) rectifies the generated alternating current into a direct current and then parallels it to a battery automatic charging controller (1205) to a super capacitor group (1206). The supercapacitor can quickly absorb a large amount of direct current. The power generating stator group is rectified into DC power in parallel and then absorbed and stored, and is electrically connected via a super capacitor battery automatic charging controller (1211). The pool (12) is charged and stored and recycled. The higher the power consumption of the multilayer common rotor (100), the greater the power consumption of the inner rotor coil group (101), and the power generation of the outer rotor coil group (102) The amount of power recharged to the battery (12) is also increased, so that the RC wireless remote control boat's navigation time and amplification distance can be extended.

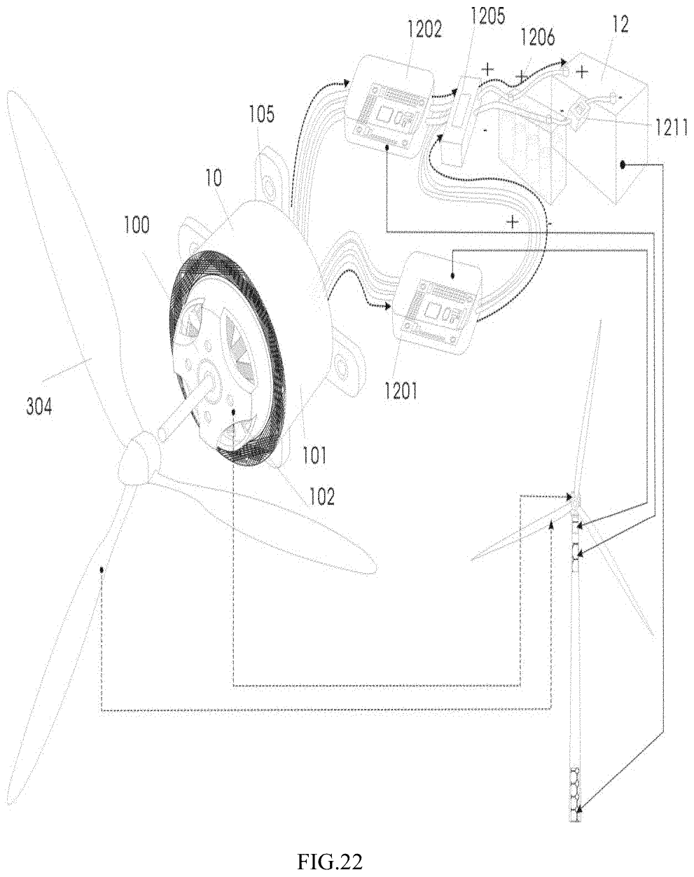

Please refer to FIG. 22, the AI artificial intelligence power and power generation multi-stator multi-function motor system device which is preferably implemented in the present invention is to fully utilize the 360-degree universal magnetic line of the multi-layer common rotor (100). Therefore, the inner stator coil group (101) is connected to the inner stator coil group full-wave rectification automatic buck-boost controller (1201), and the outer stator coil group (101) is connected to the outer stator coil group via the outer stator coil group for full-wave rectification automatic lifting The pressure controller (1202), at this time, both the inner and outer stators are rotated by the wind turbine blades (304) on the plurality of common rotors (100), and the magnetic lines of rotation are continuously inward, The outer stator coil group performs magnetic line cutting to generate current, and the alternating current generated by the two sets of rectification automatic buck-boost controllers (1201) and (1202) is rectified to full-wave by a full-wave and then connected in parallel to the battery automatic charging controller with a specific voltage. (1205) For the supercapacitor group (1206), the supercapacitor can quickly absorb a large amount of direct current characteristics, and the power generating stator group is rectified into DC power in parallel. After absorbing and storing, the battery (12) is charged, stored and recycled through the supercapacitor battery automatic charging controller (1211). Since the inner and outer stators simultaneously generate electricity, the wind turbine can be generated under the same wind and speed. The effect of a larger amount of current.

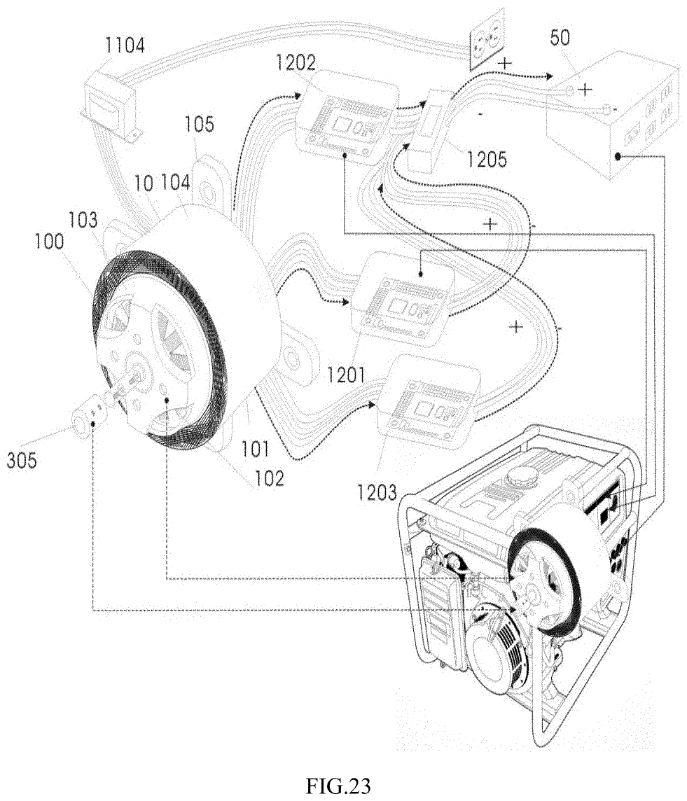

Please refer to the FIG. 23, the AI artificial intelligence power and power generation multi-stator multi-function motor system device which is preferably implemented in the present invention is a 360-degree comprehensive magnetic line for fully utilizing the common rotor (100). Therefore, the inner stator coil group (101) is connected to the inner stator coil group full-wave rectification automatic buck-boost controller (1201), and the outer stator coil group (102) is connected to the outer stator coil group via the outer stator coil group. The buck-boost controller (1202) and the outer stator coil group (103) are connected to the outer stator coil group by a full-wave rectification automatic buck-boost controller (1203) via the outer stator coil group, and the above three groups are simultaneously connected to the battery pack for automatic charging. The controller (1205) outputs a direct current of a specific voltage in parallel, and converts the direct current into an output 110V alternating current via a D/A straight AC power converter (50), wherein the outer two stator coil group (104) is connected to the alternating current transformer (1104). Provides stable AC power of 110V/60 Hz at a specific speed. At this time, both the inner and outer stators pass through the coupling (305) and steam on the multi-layer common rotor (100) shaft (1002). The shaft of the power generation engine is connected, and the engine burns the gasoline to drive the multi-layer common rotor (100) on the shaft to rotate, so the rotating magnetic lines continuously support the inner stator coil group (101) and the outer stator coil group (102). The coil group (103) and the outer two stator coil group (104) perform magnetic line cutting to generate an alternating current, wherein three sets of stator sets (101). (102) (103) convert the generated alternating current into D/A straight AC power. The device (50) outputs 110V alternating current, and a set of stators (104) simultaneously output an alternating current suitable for 110V household appliances via a set of alternating current transformers (1104), so that the inner and outer and outer two stators simultaneously generate electricity, and finally turn Simultaneous output for AC power, so that the gasoline generator can produce a larger amount of current at the same fuel consumption and speed.

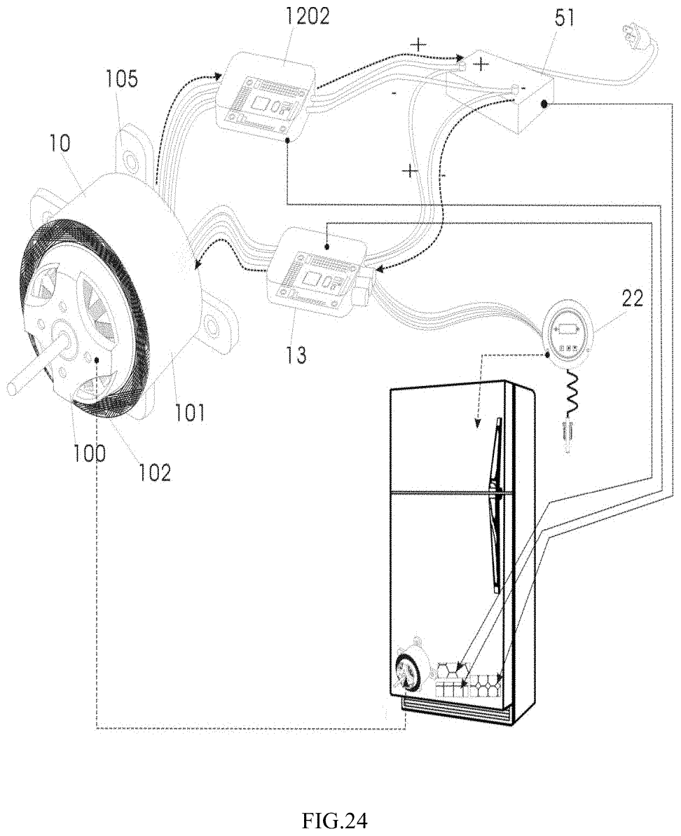

Please refer to FIG. 24, the AI artificial intelligence power and power generation multi-stator multi-function motor system system which is better implemented in this creation, because the new generation DC DC refrigerator sports mode is the first to deliver 110V AC The current is converted to DC direct current via the AC/DC power converter (51), adjusted by the automatic temperature sensing controller (22) according to the temperature to control the speed, and directly powered by the brushless motor electronic shift controller (13). The inner stator coil assembly (101) is driven to drive the multi-layer common rotor (100) to move, and the hot and cold exchange and start fan are used to adjust the temperature of the refrigerator, and the magnetic lines of the multi-layer common rotor (100) simultaneously cut the outer stator coil assembly (102). And transforming to generate current, connecting the outer stator coil group through the outer stator coil group to the full-wave rectification automatic buck-boost controller (1202) for AC-DC conversion and output and the same stable DC power as the AC-DC power converter (51), and then providing Inner stator coil group brushless motor electronic shift controller (13) power supply due to multi-layer common rotor (100) when the speed When the power consumption of the inner rotor coil group (101) is larger, the power generation amount and the electric power of the outer rotor coil group (102) are also increased correspondingly and supplied to the inner stator coil group brushless motor electronic shift controller (13) The power supply cycle is reused, so that the DC inverter DC refrigerator can consume the current generated by itself, so it can effectively reduce the power consumption.

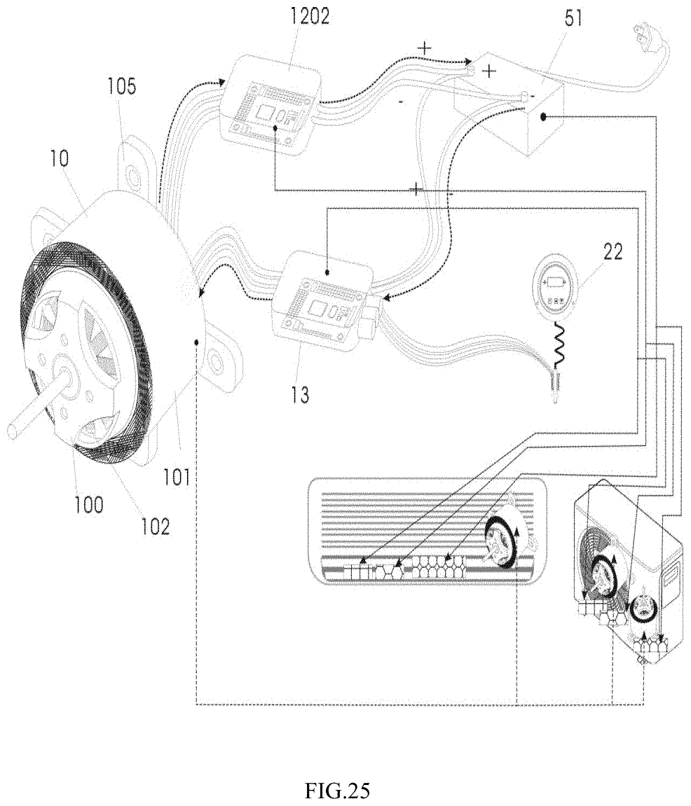

Please refer to FIG. 25, the AI artificial intelligence power, power generation multi-stator multi-function motor system system which is better implemented in this creation, because the new generation of DC DC inverter air-conditioning operation mode is 220V first The AC AC current is converted to DC DC by the AC/DC power converter (51), and is adjusted by the automatic temperature sensing controller (22) according to the temperature to control the speed, and is directly electronically shifted via the internal stator coil group brushless motor. The controller (13) supplies power to the inner stator coil assembly (101), drives the multi-layer common rotor (100) to move, performs hot and cold exchange and starts the fan to adjust the indoor temperature, and the magnetic lines of the multi-layer common rotor (100) simultaneously continue to the external stator coil. The group (102) outer stator coil group (103) and the outer two stator coil group (104) are cut and converted to generate current, and the rectifier automatic lifting voltage controller (1202) is connected via the outer stator coil group for AC/DC conversion and output. The same stable DC power as the AC/DC power converter (51) is supplied to the internal stator coil group brushless motor electronic shift controller (13) Power supply, due to the higher the rotational speed of the multilayer common rotor (100), the greater the power consumption of the inner rotor coil assembly (101), the outer rotor coil group (102) outside the stator coil group (103) and the outer two stator coils Group (104) issued by AC power (1202) External stator coil group full-wave rectification automatic buck-boost controller (1203) External sub-coil group full-wave rectification automatic buck-boost controller (1204) External two-stator coil set The wave rectification automatic buck-boost controller rectifies the DC voltage to a specific voltage and then increases it and supplies it to the inner stator coil group brushless motor electronic shift controller (13) for power supply cycle reuse, so DC variable frequency DC air-conditioning can be consumed. The current generated by itself is the main one, so it can effectively reduce the power consumption.

According to the above description of the creation structure, the novelty and progress of the creation structure are as follows: (1) The outer rotor of the inductive and permanent magnet brushless motors is designed to be hollowed out or inserted, and the position is allowed to be given up. The embedded excitation coil winding group and the permanent magnet on the outer rotor penetrate the inner and outer sides of the outer rotor of the brushless motor to fully utilize the 360-degree magnetic field line of the embedded excitation coil winding group electromagnet and the permanent magnet. The rotor further becomes a common rotor of the inner and outer stators, and the common rotor is electrically driven while the common rotor has a single side stator, and the stator coil group on the other side is cut and transformed by the permanent magnet magnetic lines to generate electricity, thereby consuming electric energy. Side-generation power generation enables a large number of inductive motors with wide applications and low cost to be multi-statared, in addition to reducing costs, and avoiding the risk of excessive concentration and control of rare earth magnets in production and production. Extend the range of single-charge commuting of various electric vehicles and reduce the power consumption of household appliances, and save more cost; (2) Common rotor Multi-layered, using a common rotor to two stators to fully utilize the 360-degree magnetic field of the permanent magnet and the excitation electromagnet, the inner stator coil set and the outer stator coil set, the two sets of stators are connected to the rectification automatic buck-boost controller With the battery charging automatic controller, covering a hollow-type common rotor power generation mode, the proportional expansion can make the generator and other equipment can generate more power generation at the same speed, when applied to wind turbines and In all kinds of generator equipment, more power can be generated without re-creating the repetitive mechanism; (3) the inner stator coil group and the outer stator coil group, and the two sets of stators are all connected to the motor electronic shift controller for power supply, The power generation mode of the common rotor with a hollow type can be extended to make the induction motor and the brushless motor generate more horsepower at the same voltage. When used for the starting acceleration of the electric vehicle, there is no need to Re-creating the repetitive mechanism and too high voltage can generate more horsepower and speed; (4) making the induction motor and the brushless motor more than the choice of the connection line group Functionalized, when all the stator sets are equipped with a set of switches, which can be powered by a set of motor electronic shift controllers or after power generation. Full-wave rectification automatic buck-boost controller is charged by the battery automatic charging controller and AC transformer The selection between the inner stator coil group and the outer stator coil group and the outer stator group and the outer two stator group can be more flexible, whether it can generate more horsepower or the same under the same voltage. At the speed of rotation, more power generation is generated, or when the purpose of electricity is used, such as when the vehicle reaches the destination, the mode of power generation is generated while the power is consumed, and the multi-layer common rotor is fully utilized. The three-dimensional magnetic line function of the excitation electromagnet and the permanent magnet is added, and the stator set switch can be selected, so that the creation can be closer to and meet the needs of various road conditions and industries; (5) Programmable logic controller Module or 32-bit 32-channel multi-channel servo steering control module, the execution mode of the write-arranged combination module is assembled into an action group, and then The setting of the target location allows the computer to analyze the artificial intelligence decision tree with the network real-time road condition and road type to assist the driver in making decisions. (6) Adding the expansion module of the coaxial multi-layer rotor group and the multi-layer stator to increase the torque or increase the power generation. the amount. The distance between the axis and the driving fulcrum is utilized to fully utilize the energy storage effect of the flywheel and the principle of leverage. (7) Inserting a high-voltage and large-ampere-capacitor super capacitor in front of the power-supply rechargeable battery pack, firstly, a large amount of DC current of the high-ampere-amplification is quickly absorbed by the super-capacitor, and then the vehicle lithium-ion battery pack is continuously charged. In order to avoid the lithium battery pack for the vehicle, the power management system BMS is a current limiting protection measure for protecting the lithium battery from overfill expansion damage or even explosion, and cannot store the multi-stator multi-function of the four tires in the vehicle. The loss of the huge power generation current generated by the motor effectively recycles the power generated by the amount of running inertia during the vehicle travel to expand the travel distance and use time of the electric vehicle locomotive and various vehicles and home appliances. (8) The battery pack is connected with a 4000 watt DC-to-AC pure-spinning power converter, which becomes a generator mode that can output 110V or 220V household power for household appliances. The system can automatically adjust according to power consumption and battery voltage. The expandable AI artificial intelligence power generation multi-stator multi-function motor system device speed achieves the purpose of balancing the power output. Therefore, the new type of electric vehicle with the expandable AI artificial intelligence power generation multi-stator multi-function motor system can become a small mobile power station when going out for camping and office work. When returning to the underground parking lot, it can be transmitted via the power transmission system. Electricity is transferred from the underground parking lot to the home for use by other household appliances to achieve special functions of energy saving and carbon reduction. (9) When the induction motor and the permanent magnet type brushless motor are applied to the electric vehicle industry, the structure of one of the existing engines and the four-wheel structure can be used as reference, that is, a total of five times of electricity, multiple force, and more are used. Stator multi-function external-rotation brushless motor, in which one original engine is used, the main force can be changed to the power or the electric drive mode according to the demand, and the other four wheels can be the power generation mode of the electric power. The combination of intelligent power and power generation multi-stator multi-function motor use mode is equivalent to the fuel used by current car engines, which is generated by its four wheels. Therefore, the operation of this mode will make the electric vehicle's endurance exceed the current commuting distance using gasoline as fuel. Limit and significantly reduce fuel costs and environmental burden, and in the case of uphill and high load conditions, the double force mode can be used, or vice versa, the core power at the engine position becomes the generator, and the four wheels become the active drive of the power supply. Off-road four-wheel drive mode, which can greatly enhance the practical value of this creation, and improve the product of double-power, multi-force, multi-stator multi-function external rotary brushless motor system device And superiority, enhancing the value of the use of external rotation type brushless motor industry. (10) Use the driving computer and navigation module and 4G network to pre-route the departure point to the destination. Analysis of options such as destination distance, road type, average speed, real-time traffic conditions in the cloud, power consumption, power generation, and flat road ratio. In order to estimate the time required to reach the destination and the remaining vehicle power after arriving at the destination as the evaluation standard, the travel time with the shortest required time and the most remaining power is prioritized, as the result of the decision tree analysis, after being recommended to the driver, and based on the recommendation According to the road type of each road section of the road path, the multi-function switch selection action combination of the stator line group corresponding to the road type is selected. The automatic deployment route task automatic allocation table automatically performs the multi-stator multi-function stator line group selection switch action group combination of the road segment according to the 3D coordinates of the satellite positioning. During the vehicle travel, the driving computer can be directly controlled by the PLC programmable logic controller module or the 32-bit 32-channel multi-channel servo steering controller by the automatic navigation module, and can also directly control the function switching switch action groups of each stator group. The GPS module of the automatic navigation module, the electronic compass, the gyroscope and other commands operate the throttle, the direction, the front and rear, the light, the brake, and the like, and the automatic detection of the optical radar, the tire pressure by the driving computer connected sensing fusion device Meters, accelerometer magnetometers, radars and CMOS cameras, G Sensors, inertia meters, pressure gauges, chemical sensors, ultrasonic sensors and other detection systems. Automatically scan the current situation of surrounding vehicles, and perform trend prediction analysis based on inertia and dynamics to remind drivers or take proactive measures before the obstacles in the path can be affected to achieve the purpose of AI artificial intelligence assisted driving.

The above descriptions are only for the preferred embodiments of the present invention, and are not intended to limit the scope of implementation of the present invention, and any other changes and modifications or equalities arranged in the same spirit and scope of the present invention, Both are covered by the scope of the creative protection and the scope of patents.

This creation is based on the above characteristics and is a very outstanding and excellent design; it is not found in the publication or public use, and is suitable for the application requirements of the new patent, and is submitted in accordance with the law.

What is claimed is:

1. An expandable AI artificial intelligence power, power generation multi-stator multi-function motor and system device, comprising the expandable AI artificial intelligence power, power generation multi-stator, multi-function motor and system device comprises a motor body, and has a concentric single-layer or multi-layer common rotor, and the rotor wall of each layer of the concentric single-layer or multi-layer common rotor is embedded Having at least one first magnetic member and at least one second magnetic member and simultaneously passing through the inside and outside of the rotor wall, so that the 360-degree magnetic enthalpy of the at least one first magnetic member and the at least one second magnetic member on the concentric single layer or the plurality of common rotors are completed Presenting and being fully utilized, and a multi-layer stator drive base and extending a two-layer stator with a layer of rotor to fully utilize a 360 degree internal and external magnetic field relationship, the at least one first magnetic member and the at least one second The magnetic poles of the magnetic member are opposite to each other, and the first magnetic member and the second magnetic member are both permanent magnets or electromagnets. When used as a generator, the magnetic poles are generated by different magnetic poles of a single magnetic body. More current, when used as a motor, pushes the same magnet to generate greater torque by generating different magnetic poles inside and outside the stator.

2. The expandable AI artificial intelligence power, power generation multi-stator multi-function motor and system device of claim 1, wherein the expandable AI artificial intelligence power, power generation multi-stator multi-function motor and system device mainly comprise a common rotor structure, and the rotor structure thereof, in the hollow design, the permanent magnet magnet or the excitation winding coil set on the rotor can be inserted into the inner and outer sides of the rotor to form a common rotor, wherein the common rotor bearing of the field winding coil set is put into the current collecting The ring supplies power to the field winding coil group, and the collector ring brush is locked on the inner stator group to supply power to the common rotor field winding coil group to generate a magnetic field, or via a wireless power supply coil on the stator group. The wireless power transmission mode supplies power to the wireless power receiving line group above the common rotor cover to conduct a magnetic field generated by the excitation winding coil group located on both sides of the rotor wall of the layer, except for the internal stator coil group connected to the brushless motor electronic shift control In addition to driving the brushless motor rotor, a set of outer stator coil sets are arranged on the outer edge, and a full-wave rectification automatic buck-boost control panel and a rechargeable battery are automatically charged. The controller, when the motor is driven by the electronic shifting controller of the motor to drive the stator coil assembly of the motor to drive the excitation winding coil electromagnet or the permanent magnet of the inner edge of the common rotor, the excitation winding coil electromagnet of the outer edge or The permanent magnet type magnet rotates at the same time, so the magnetic field line of the stator coil group of the outer ring of the rotor is cut by the magnetic field of the exposed magnet of the rotor to cut the outer stator coil, thereby generating alternating current electric energy, and is full-wave rectified to direct current through the automatic buck-boost controller to output a specific voltage. Charging the supercapacitor in parallel and then charging the battery, so that the user can achieve the power consumption, while the power generation cycle and charging, effectively extend the driving distance of the electric vehicle vehicle and various aircraft and electric models and drive all kinds of motors. The household appliances have been able to significantly reduce the consumption of power resources, energy saving and carbon reduction.

3. The expandable AI artificial intelligence power, power generation multi-stator multi-function motor and system device of claim 1, wherein the expandable AI artificial intelligence power, power generation multi-stator multi-function motor and system device mainly comprise a common rotor structure, and the rotor structure thereof In the hollow design, the permanent magnet or the excitation winding coil set on the rotor can be inserted into the inner and outer sides of the rotor to form a common rotor, and a certain subgroup is added outside the common rotor to fully utilize the magnet 360. The magnetic enthalpy becomes a common rotor-to-multi-stator structure, and after the stator power supply line group, a pair of two-wire group function selection switches are added, one set is connected to the electronic governor to supply the drive motor, and the other group is connected to the full-wave rectifier, The power is converted from alternating current to direct current, and a multi-function selector switch is added to the pair of second-line units to control the servo steering gear, so that the function of the stator can be switched between the power generation output and the power supply driving motor, and the program can be programmed. Logic controller module or 32-bit 32-channel multi-channel servo steering control module to control the function of the multi-function selector switch Each stator selector switch is combined with a servo steering gear, that is, a visual field, and all the stator function selection servos are combined with different torque and power output, defined as different road conditions, each stator switch The driving state mode under the channel arrangement combination is coded in advance, and is written into the execution mode instruction set of each permutation combination module, and then assembled into an action group instruction set macro according to different positions and various detector states. In order to achieve the purpose of multi-stator multi-arranged combination of automatic control.

4. The expandable AI artificial intelligence power, power generation multi-stator multi-function motor and system device of claim 1, wherein the expandable AI artificial intelligence power, power generation multi-stator multi-function motor and system device mainly comprise a common rotor sleeve and multiple stators and Multi-stator multi-function expansion kit combination of electronic governor and full-wave rectifier or power supply drive and power generation rectification function selection switch, its rotor sleeve structure is hollow design, so that permanent magnet or excitation winding coil on the rotor The group can be inserted into the inner and outer sides of the rotor, and can be directly locked above the common rotor of the multi-stator motor, and on the inner and outer sides of the rotor sleeve, each additional sub-group lock is added to the sub-group expansion base to fully utilize the magnet 360 The magnetic enthalpy becomes a multi-layer common rotor-to-multi-stator structure for power supply to increase motor torque or output output rectification to increase power generation, or to select one function through the selection switch, to rotor sleeve and multi-stator and electronic tuning Speed reducers and rectifiers and multi-function selector switch expansion kits to increase motor torque or power generation.

5. The expandable AI artificial intelligence power, power generation multi-stator multi-function motor and system device of claim 1, wherein the expandable AI artificial intelligence power, power generation multi-stator multi-function motor and system device mainly comprise a rotor sleeve and a multi-stator group and Multi-stator multi-function expansion kit combination of electronic governor and full-wave rectifier or power supply drive and power generation rectification function selection switch, its rotor sleeve structure is hollow design, so that permanent magnet or excitation winding coil on the rotor The group can be inserted into the inner and outer sides of the rotor, and can be directly locked on the common rotor of the rotor of the general external rotary brushless motor or the multi-stator multi-function external rotary brushless motor, and on the inner and outer sides of the rotor sleeve, each A certain subgroup is additionally locked to the stator set expansion base to make full use of the 360 degree magnetic yoke of the magnet to become a multi-layer common rotor-to-multi-stator structure, which is used for power supply driving to increase motor torque or output output warping full-wave flow to enhance power generation. Quantity, or select one of the functions via the selector switch, with rotor sleeve and multi-stator and electronic governor and full-wave rectifier or multi-function selector switch expansion kit The general external rotation type brushless motor is upgraded to a multi-stator multi-function power generation motor or a multi-stator multi-function power, motor torque or power generation.

6. The expandable AI artificial intelligence power, power generation multi-stator multi-function motor and system device of claim 1, wherein the expandable AI artificial intelligence power, the power generation multi-stator multi-function motor and the system device rotor are hollowed out, so that the rotor is The field winding coil set can be inserted into the inner and outer sides of the rotor, and the power supply through the brush on the stator group is applied to the collector ring on the rotor bearing to conduct a magnetic field generated by the field winding coil group running through the two sides of the layer of the rotor wall. And a certain sub-group is added to the outer layer of the rotor, and the ratio of one layer of the rotor to the two sets of stator sets is a single stator using a 180-degree magnetic field, which becomes a common rotor between the two sets of stator groups, so as to fully utilize the characteristics of the magnetic field 360 degrees, according to the demand. The two stator sets are simultaneously powered by an electronic governor to generate a magnetic field to drive the common rotor to drive the hoisting torque of the motor, or to drive the common rotor by an external force, while magnetically cutting the two stator sets to generate more power, or to supply power to a stator group. The governor generates a magnetic field to drive the common rotor drive, and the other stator group performs magnetic line cutting to generate electricity and is full-wave rectified. The battery is charged in parallel, so that the inductive motor can also be multi-stator, multi-functional, and can be extended from the axis by a layer of rotor to two stator groups according to requirements, and become a two-layer common rotor pair four. The stator, or the three-layer common rotor, adjusts the structure of the six-stator group to achieve power generation, power generation, and electric power generation, and recycle power users.

7. The expandable AI artificial intelligence power, power generation multi-stator multi-function motor and system device of claim 1, wherein the expandable AI artificial intelligence power, the power generation multi-stator multi-function motor and the system device rotor are hollow design, so that the rotor is The excitation winding coil set can be inserted into the inner and outer sides of the rotor, and the wireless power supply coil on the stator set is powered by the wireless fusible mode to the wireless power receiving line group in the upper part of the rotor cover. The excitation winding coil group generates a magnetic field, and a certain subgroup is added to the outer layer of the rotor, and the ratio of one layer of the rotor to the two sets of stator groups becomes a common rotor between the two sets of stator groups, so as to fully utilize the characteristics of the magnetic field 360 degrees. Two stator sets are simultaneously powered by the electronic governor to generate a magnetic field to drive the common rotor to drive the hoisting torque of the motor, or to drive the common rotor by external force, and simultaneously perform magnetic line cutting on the two stator sets to generate more power; or one stator group The power supply electronic governor generates a magnetic field to drive the common rotor drive, and the other stator group performs magnetic line cutting to generate electric power, and after full-wave rectification, the battery is charged in parallel, so that the inductive motor can also be multi-stator, multi-functional, wireless Modification, brushless, and according to the demand, a layer of rotor to two stator groups, extending from the axis to become a two-layer common rotor to four stator, or three-layer common rotor to six stator group structure adjustment In order to achieve the power generation, power, power generation, cycle power users.

8. The expandable AI artificial intelligence power, power generation multi-stator multi-function motor and system device of claim 1, wherein the expandable AI artificial intelligence power, the power generation multi-stator multi-function motor and the system device drive the power generation and the power generation simultaneously The motor power system drives the tire to rotate to cause the vehicle to move, and the four tires rotate at the same time. The multi-stator motor in the wheel frame drives the rotating cutting magnetic field by external force and becomes a large amount of electric power generated by the multi-stator generator, which is different from the multi-stator driving motor. The power generated by the stator is rectified by full-wave rectification into DC power in parallel. First, a large amount of DC power is charged into a high-voltage and large-ampere-capacitor super capacitor. The super-capacitor can quickly absorb the characteristics through a large current and then absorb the characteristics. The group is continuously charged. The electric power generated by the four multi-stator multi-function motor generators due to the inertia of the vehicle is stored in time to expand the driving distance and usage time of the electric vehicle locomotive and various vehicles and home appliances.

9. The expandable AI artificial intelligence power, power generation multi-stator multi-function motor and system device of claim 1, wherein the expandable AI artificial intelligence power, the power generation multi-stator multi-function motor and the system device rotor are hollowed out, so that the rotor is The permanent magnet magnet or the excitation winding coil set can be inserted into the inner and outer sides of the rotor. If the excitation winding coil group passes through, the brush on the stator group supplies power to the collector ring on the rotor bearing. The excitation winding bobbin group running through the two sides of the rotor wall generates a magnetic field, and a certain subgroup is added to the outer layer of the rotor to form a common rotor between the two sets of stator groups, so as to fully utilize the characteristics of the magnetic field 360 degrees; A near-axis stator group-powered electronic governor generates a magnetic field-driven common-rotor drive, but does not output a power-driven vehicle-moving generator mode for the wheel set, and the other plurality of stator sets perform magnetic line cutting due to common rotor rotation to generate AC power through the entire After the wave rectification is DC power, after charging in parallel, the super capacitor is charged, then the battery is charged by the super capacitor, and the battery pack is connected to the DC power to the AC. The electric power converter converts the direct current into a 110 volt household appliance using an AC power output, and the system automatically adjusts the rotational speed and the power generation amount by the battery voltage and the power output output, thereby satisfying people's going out and household electricity if the mobile power station is operated. Need to use electricity to generate electricity and recycle power users.

10. The expandable AI artificial intelligence power, power generation multi-stator multi-function motor and system device of claim 1, wherein the expandable AI artificial intelligence power, the power generation multi-stator multi-function motor and the system device rotor are hollowed out, so that the rotor is The permanent magnet magnet or the excitation winding coil set can be inserted into the inner and outer sides of the rotor. If the excitation winding coil group passes through, the brush on the stator group supplies power to the collector ring on the rotor bearing. The excitation winding bobbin group running through the two sides of the rotor wall generates a magnetic field, and a certain subgroup is added to the outer layer of the rotor to form a common rotor between the two sets of stator groups, so as to fully utilize the characteristics of the magnetic field 360 degrees; A near-axis stator group-powered electronic governor generates a magnetic field-driven common rotor drive, but does not output a power-driven vehicle generator mode for the wheel set, and the other plurality of stator sets perform magnetic line cutting due to common rotor rotation to generate alternating current power, among The alternating current generated by part of the stator group is connected to a transformer, and the voltage of the alternating current generated by controlling the fixed speed is adjusted by the transformer to The 110V household power output is directly used by household appliances. The AC power generated by other stator sets is rectified to DC by full-wave rectification, and the battery is charged in parallel. The battery pack is connected to a DC-to-AC power converter to convert the DC power to 110 volts. By using the AC power output, in addition to converting the power of the battery from the DC AC power converter to the AC output, the AC power from the other stator is directly adjusted to the AC power used by the 110 volt household appliance. This can create more electricity for household appliances. If the mobile power station meets the needs of people going out and household electricity, it will generate electricity and recycle power users.

11. Application of driving computer and 3D navigation module and 4G or 5G mobile communication broadband network, pre-deployment route from destination to destination, destination distance, road type, average speed, network cloud real-time traffic conditions Update and expandable AI artificial intelligence power, power generation multi-stator multi-function motor and system equipment operation according to the slope and load driving different multi-stator power consumption and generated power generation database data, Yiping Road ratio and other options for analysis. In order to estimate the time required to reach the destination and the remaining vehicle power after arriving at the destination, the shortest required time and the most remaining driving route are prioritized, and the decision tree analysis result is preferentially recommended to the driver. After the driver confirms the driving route and according to the road type according to the recommended road path, the corresponding type of the multi-function switch of the stator line group is selected according to the road type. In the self-expanding AI artificial intelligence power, power generation multi-stator multi-function motor and system device in different sections of the automatic unfolding driving path, the task automatic allocation table combination instruction set of each stator group between multiple stators is automatically according to the 3d coordinates of the satellite positioning The multi-stator multi-functional stator line group selection switch action group combination instruction set of the road section is executed. During the vehicle travel, the driving computer is directly or indirectly controlled by a 32-bit 32-channel multi-channel servo steering controller or PLC through an automatic navigation module. The stylized logic controller can directly control the action group of each stator group function switch switch, and can also operate the throttle, direction, front and rear, lighting, brake wiper, etc. by means of the GPS module of the automatic navigation module, electronic compass, gyroscope and the like. Various types of control, automatic detection of optical radar by driving computer connected sensor fusion, tire pressure gauge, accelerometer magnetometer, radar and CMOS camera, G Sensor, inertial meter, pressure gauge, chemical sensor, ultrasonic Detection system such as sensor; automatic scanning of surrounding vehicle driving status confirms object type according to the picture taken by CMOS camera, and Its inertia and dynamic trend forecasting analysis to alert the driver or the 32-bit 32-channel multi-channel servo steering controller or PLC programmable logic directly in the emergency situation before the traffic path obstacles may be affected. The controller controls the throttle power output, direction, and brakes to take proactive measures to achieve the overall planning to automatically execute the command set macros' immediate response to detect system-assisted methods to achieve AI artificial intelligence assisted driving and unmanned self-driving vehicles.

12. The expandable AI artificial intelligence power, power generation multi-stator multi-function motor and system device of claim 1, which can be controlled by a multi-stator group line group function selection switch Each switch between the power supply drive and the rectified charge after power generation, and the drive computer selects all the stator set selection switches through a 32-bit 32-channel servo controller or a PLC programmable logic controller, and then arranges and combines them. The core power expandable AI artificial intelligence power, power generation multi-stator multi-function motor is selected to actively provide the driving force function, and the four expandable AI artificial intelligence power and power generation multi-stator multi-function motor in four tire wheel frames are driven. Passively rotate, and generate electricity, become a three-phase multi-stator AC generator, and then rectify to DC power by full-wave rectification, output a specific voltage through an automatic buck-boost charge controller, connect in parallel, charge the super capacitor, and then charge the vehicle battery pack. Power supply to the core power expandable AI artificial intelligence power, power generation multi-stator multi-function motor continues to provide mechanical kinetic energy, The cycle is used, and vice versa, all the stator group selection switches can be changed by the car computer via the 32-bit 32-channel servo controller or the PLC programmable logic controller. After the array is combined, the power supply is selected to four in four. The electronic governor of the expandable AI artificial intelligence power and power generation multi-stator multi-function motor in the tire wheel frame actively generates mechanical kinetic energy and becomes a four-wheel direct drive mode. At this time, the expandable AI artificial that originally provided the core power The intelligent power and power generation multi-stator multi-function motor selects the power generation function, and the battery is powered by the electronic governor of the single stator group of the motor, which drives the common rotor to rotate, but does not output the power to the tire drive system to drive the vehicle, only as electricity The multi-stator generator used for power generation uses the other multi-stator group function line group in the motor to select the function of the rectification power generation line group. The AC current output is generated by the common rotor magnetic field line transformation and cutting, and is automatically converted to DC after full-wave rectification. After the buck-boost is connected to a specific voltage in parallel, the supercapacitor is charged first, and then the supercapacitor is used to charge the car battery pack. The line is continuously charged, and the power is supplied to the independent stator and multi-function motor located in the four-wheel frame, and the four-wheel drive mode for actively driving the driving force of the vehicle is actively generated, so that the multi-stator group line group function selection switch can be respectively The power supply drive and the power generation are switched between rectified and charged, and all the stator group selection switches are selected by the driving computer via a 32-bit 32-channel servo controller or a PLC programmable logic controller, and the driving mode or the power generation mode is predefined. After arranging and combining, to achieve the core driving force and the four expandable AI artificial intelligence power in the four-wheel frame, the multi-stator multi-motor is generated in the core multi-stator multi-function motor, and the four-wheel power is directly used. The driving mode and the core multi-stator multi-function motor power supply drive provide mechanical kinetic energy, so that the multi-stator multi-function motor in the four-wheel frame is passively rotated, and becomes a special function for switching among different modes such as four multi-stator generators.

13. Brush the brush motor, replace the brush power supply with the wireless power transmitter board and the wireless power receiving coil module, place the wireless power transmitter board above the stator, and place the wireless power receiving coil module on the rotor cover. In the upper inner side, instead of the contact type power supply mode of the brush motor, the brush motor can also make the winding coil on the rotor magnetically become an electromagnet, thereby becoming a brushless motor and reducing unnecessary Loss and resistance, increase the life of the motor.

14. The expandable AI artificial intelligence power, power generation multi-stator multi-function motor and system device of claim 1, wherein the power can be multiplied, the power, the AI artificial intelligence is automatically controlled, and the side is used. While charging, the terminal application device is an electric vehicle.

15. The expandable AI artificial intelligence power, power generation multi-stator multi-function motor and system device of claim 1, wherein the power generation, the power, the AI artificial intelligence automatic control, and the side edge Charging, the terminal application device is an electric motor vehicle.

16. The expandable AI artificial intelligence power, power generation multi-stator multi-function motor and system device of claim 1, wherein the terminal device can be charged while the terminal application device is a remote control aircraft model.

17. The expandable AI artificial intelligence power, power generation multi-stator multi-function motor and system device of claim 1, wherein the terminal application device is an unmanned multi-axis aircraft model.

18. The expandable AI artificial intelligence power, power generation multi-stator multi-function motor and system device of claim 1, wherein the terminal device can be charged while the terminal application device is a remote car model.

19. The expandable AI artificial intelligence power, power generation multi-stator multi-function motor and system device of claim 1, wherein the same speed can generate a larger amount of current, and the terminal application device is wind power.

20. The expandable AI artificial intelligence power, power generation multi-stator multi-function motor and system device of claim 1, wherein the same speed can generate a larger amount of current, and the terminal application device is gasoline.

21. The expandable AI artificial intelligence power, power generation multi-stator multi-function motor and system device of claim 1, wherein the power can be supplied while power is being used, and the terminal application device is a refrigerator.

22. The expandable AI artificial intelligence power, power generation multi-stator multi-function motor and system device of claim 1, wherein the power can be supplied while power is being used, and the terminal application device is air-conditioning.
